(19) United States
(12) Patent Application Publication
(10) Pub. No.: US 2018/0374115 A1
(43) Pub. Date: Dec. 27, 2018

(54) MANAGING DIGITAL PACKAGE INVENTORY AND RESERVATIONS

(71) Applicant: Adobe Systems Incorporated, San Jose, CA (US)

(72) Inventors: Surbhi Aggarwal, New Delhi (IN); Praveen Kumar Goyal, Noida, U.P. (IN); Prashant Dahiya, Noida, U.P. (IN); Prakash Tripathi, Noida, U.P. (IN); Niraj Gupta, Faridabad (IN); Kumar Mrityunjay Singh, Bengaluru (IN); Atul Shrivastava, Noida (IN); Ashish Duggal, Ashok Nagar (IN); Jonathan David Tabak, Los Angeles, CA (US)

(21) Appl. No.: 15/630,300

(22) Filed: Jun. 22, 2017

(51) Int. Cl. G06Q 30/02

(52) U.S. Cl. CPC G06Q 30/0243; G06Q 30/0204; G06Q 30/0254; G06Q 30/0244

(57) ABSTRACT

The present disclosure is directed towards systems and methods for adjusting impression inventory within overlapping packages and based on impression inventory reservations. The systems and methods receive attributes of a first package and a second package to create impression inventories for the first package and the second package. Additionally, the systems and methods determine overlap between the impression inventory of the first package and the impression inventory of the second package. Moreover, upon receiving an inventory reservation request, the systems and methods adjust, based on the reservation request, the impression inventories of both the first package and the second package.

### BACKGROUND

Content publishers typically create and provide an inventory of digital ad slots to third parties (e.g., advertisers) within published digital content. The inventory, for example, often includes time slots dispersed before, within, or after a presentation of publisher content (e.g., a digital video presentation such as a movie, series, or sporting event). Conventionally, the publisher provides the inventory in content-based packages that are based on characteristics of the publisher content (e.g., action, sports, drama). Increasingly, however, third parties are demanding more complex packages that allow a third party to more precisely target specific audience segments.

In response to demand, some publishers can provide packages in which a third party can define various characteristics to target particular audience segments, where the package includes available impressions (e.g., ad slots) that match the various characteristics that define the audience segment. For example, a publisher can create a package that defines audience segment characteristics, such as content (e.g., series name or content genre), user characteristics (e.g., age, gender, location), and/or device characteristics. Due to defining the packages based on multiple audience segment characteristics, the publisher creates packages that overlap one another based on shared audience segments. Based on the complexities of generating and managing overlapping packages, however, conventional systems have several disadvantages.

For example, when a publisher creates overlapping packages, conventional systems typically double-count available impression inventory. As mentioned above, many conventional systems create a package by segmenting groups of individual impressions maintained in an inventory database that correspond to the audience characteristics associated with the package. Packages overlap when individual impressions are assigned to more than one package. When an individual impression within an inventory database is assigned to multiple packages, conventional systems fail to properly account for the individual impression. Instead, conventional systems assign the individual impression to each of the multiple packages within the inventory database. Accordingly, when conventional systems query the inventory database to access/assign an individual impression within the inventory database, conventional systems do not recognize that the individual impression is also assigned to other packages within the inventory database. Due to this limitation, conventional systems often over count the number of available impressions within an inventory database for a particular package.

For example, a first package can include audience segments of gender=males; and age=20-35. A second package can include audience segments of genre=sports; and device=smart phone. As can be understood, a portion of audience members within the first package can also be audience members in the second package, and this portion of audience members is the overlap between the first package and second package. While inventory databases within conventional systems are capable of managing packages based on a single content-based segment definition, conventional system inventory databases are unable to accurately and effectively account for a multi-characteristic-based segment definition of an audience segment that often creates a package overlap within an inventory database. As such, conventional systems often double count inventory by double assigning the portion of impression inventory within the overlap to each package of the overlapping packages.

Because conventional systems double count the impression inventory within overlapping packages, conventional systems often query the inventory database, double count the impressions within the overlap, and generate incorrect impression inventory quantities within the inventory database (i.e., a misleading inventory forecast). The foregoing can result in the publisher overbooking the overlap between packages (i.e., booking the same overlap two or more times) and exceeding actual available inventory within the inventory database, and as a result, conventional systems cannot generate an accurate inventory forecast when forecasting overlapping packages. Moreover, overtime, the impression inventory data within the inventory database becomes more and more corrupt, and eventually could lead to an inventory database that includes such unreliable data that the inventory database is no longer usable.

Additionally, when higher valued packages overlap with lower valued packages within the database, conventional systems do not distinguish between segments within the database representing differing valued packages. Accordingly, conventional systems often unintentionally misuse overlapping inventory with a lower valued package instead of more efficiently using the overlapping inventory with a higher valued package. Therefore, conventional systems often unintentionally reducing the amount of available inventory for the higher valued package based on inconsistencies between the inventory database and the actual amount of impressions.

Accordingly, these and other disadvantages exist with respect to conventional systems.

### BRIEF SUMMARY

The various embodiments described below provide benefits and/or solve one or more of the foregoing or other problems in the art with systems and methods for managing availability of audience impression inventory within overlapping packages (i.e., audience impression packages) that are based on one or more impression dimensions (e.g., content and audience characteristics). For example, the systems and methods manage a database of impression inventory of available impressions where one or more impressions of the impression inventory correspond to multiple packages (i.e., defined as being within multiple audience segments of the inventory database simultaneously). Specifically, the systems and methods organize and monitor an inventory database to determine impression overlap between multiple packages. Moreover, the systems and methods allow for a prioritization of packages, and based on the prioritization, the systems and methods assign overlap impressions to a single package from the overlapping packages within the inventory database. For example, the systems and methods seamlessly adjust impression inventory within the inventory database between overlapping packages to maintain accurate inventory data within the inventory database, as well as control use of overlapping impression within the inventory database. Accordingly, the systems and methods provide an accurate overall availability of impression inventory within each of the overlapping packages.

Additionally, the systems and methods adjust an availability of impressions within a given package with the inventory database based on receiving an inventory reservation request (i.e., a booking) from a third-party provider system corresponding to an overlapping package. For example, the systems and methods determine a package's exclusive inventory (e.g., impressions that do not overlap other packages) and overlap inventory within the inventory database. The systems and methods allocate the exclusive impressions for first use in response to reservations requests of the package then enable a strategic consumption of any overlap impressions between the overlapping packages.

For example, the systems and methods utilize a specialized algorithm to assign impressions segmented as overlap impressions within the inventory database to an inventory reservation request based on assigned priority and associated values of the overlap impressions. Furthermore, based on the consumption of overlap impressions, the systems and methods reduce an overall availability of overlap impressions within the inventory database by marking the overlap impressions as reserved to accurately update impression inventory and avoid double-counting overlap impressions between packages. As a result, the systems and methods maintain the integrity of inventory data within the inventory database, provide an accurate forecasting of impression inventory within the inventory database and to third-party provider systems, prevent assigning overlap impressions within the inventory database to two or more packages, and/or minimize assigning more valuable overlap impressions to less valuable packages within the inventory database.

Additional features and advantages of the embodiments will be set forth in the description that follows, and in part will be obvious from the description, or may be learned by the practice of such example embodiments. The features and advantages of such embodiments may be realized and obtained by means of the instruments and combinations particularly pointed out in the appended claims. These, and other features, will become more fully apparent from the following description and appended claims, or may be learned by the practice of such example embodiments as set forth hereinafter.

### BRIEF DESCRIPTION OF THE DRAWINGS

Various embodiments will be described and explained with additional specificity and detail through the use of the accompanying drawings in which:

FIG. 1 illustrates a schematic representation of an environment within which an inventory planning system can operate in accordance with one or more embodiments of the present disclosure;

FIGS. 2A-2B illustrate a sequence-flow diagram for managing impression inventory within packages in accordance with one or more embodiments of the present disclosure;

FIG. 3 illustrates a flow chart for adjusting impression inventory within packages in response to an inventory reservation request corresponding to an overlapping package in accordance with one or more embodiments of the present disclosure;

FIG. 4 illustrates a schematic representation of overlapping packages in accordance with one or more embodiments of the present disclosure;

FIGS. 5A-5E illustrate impression inventory tables of overlapping packages demonstrating impression availability adjustments within each of the overlapping packages based on receiving an inventory reservation requests according to one or more embodiments;

FIG. 6 illustrates a schematic representation of a graphical user interface for creating a package according to one or more embodiments of the present disclosure;

FIG. 7 illustrates a schematic representation of a graphical user interface for presenting impression inventory of packages according to one or more embodiments of the present disclosure;

FIG. 8 illustrates a schematic representation of a graphical user interface for creating an inventory reservation request in accordance with one or more embodiments of the present disclosure;

FIG. 9 illustrates a schematic representation of a graphical user interface for presenting impression inventory and receiving inventory reservation requests according to one or more embodiments of the present disclosure;

FIG. 10 illustrates a schematic representation of a graphical user interface for indicating that impression inventory for a package is overbooked according to one or more embodiments of the present disclosure;

FIG. 11 illustrates a flowchart of an example method for adjusting impression inventory of packages according to one or more embodiments of the present disclosure; and

FIG. 12 illustrates a block diagram of an example computing device in accordance with one or more embodiments of the present disclosure.

### DETAILED DESCRIPTION

The various embodiments described herein provide an inventory analytics and planning system (or simply “planning system”) for accurately managing and adjusting availabilities of audience impression inventory data associated with publisher content (e.g., an amount of discrete available ad impressions associated with a digital video presentation) within an inventory database. In some embodiments, the inventory planning system allows for a publisher system to cause the creation of overlapping packages of impressions, where overlapping packages include a segmented portion of inventory data within the inventory database that overlaps with a segmented portion of inventory data of at least one other package within the inventory database. To accurately and effectively manage overlapping impression inventory within the inventory database of the inventory planning system, the inventory planning system prioritizes packages within the inventory database based on assigned priorities from a publisher system, and assigns overlap impressions within the inventory database to a specific package based on the prioritization. Moreover, the inventory planning system adjusts an overall impression inventory within overlapping packages based on receiving an inventory reservation request for an overlapped package. For example, the inventory planning system adjusts a number of available impressions of the overall impression inventory within the inventory database of the inventory planning system.

In one or more embodiments, a publisher system can monitor user devices and track digital content viewed by the user devices. Moreover, the inventory planning system can communicate with the publisher system to access and analyze the tracked content (i.e., historical analytics data). Based on analyzing the historical analytics data, the inventory planning system can predict future digital content consumption from the user devices, and as a result the inventory planning system can generate audience impression inventory data. The audience impression inventory data is maintained within an inventory database of the inventory planning system to allow the publisher or third-parties to communicate with the inventory database to reserve portions of the audience impression inventory.

In some embodiments, for example, a content publisher (e.g., a producer, broadcaster, or provider of media content) can access the inventory planning system via a user device and cause the inventory planning system to create packages that include a portion of impressions from the impression inventory within the inventory database that target specific audience segments defined by multiple impression dimensions. In particular, the inventory planning system can segment the impression inventory within the inventory database and assign impressions of the impression inventory to one or more of the packages within the inventory database. As a non-limiting example, a content publisher can access and use the inventory planning system via a user device to create a package based on selecting audience member attributes (e.g., age, gender, location), content attributes (e.g., title, genre, rating), and/or other attributes (e.g., time of day, day of week) associated with each impression instance within the inventory database. Accordingly, the inventory planning system allows a publisher to create digital packages that each include a defined amount of impressions (i.e., an impression inventory) that match the selected attributes. In other words, each package includes an anticipated amount of impressions that match the user-selected attributes corresponding to anticipated presentations of publisher content.

Because the inventory planning system creates packages defined by multiple impression dimensions, the inventory planning system can create overlapping packages, or in other words, where there exists a set of impressions that simultaneously match attributes corresponding to multiple packages (i.e., are segmented within the inventory database of the inventory planning system as being within multiple packages). For example, a first package can include impressions matching the attributes: [males+sports genre]. Additionally, a second package can include impressions that match the attributes: [males+ages 20-35]. Accordingly, in this example, the first package and the second package are overlapping packages because a portion of impressions that match [males+sports genre] also match [males+ages 20-35], where the overlap impressions include those impressions that match the attributes: [males+sports genre+ages 20-35].

To manage impression inventory of overlapping packages, in some embodiments, the inventory planning system prioritizes packages within the inventory database of the inventory planning system. For example, a publisher, via a user device, can cause the inventory planning system to assign respective priorities to overlapping packages within the inventory database. For instance, the publisher, via the user device, can cause the inventory planning system to associate overlapping packages with respective priorities within the inventory database. In particular, the inventory planning system can segment the impression inventory based on the respective priorities of the overlapping packages in addition to the attributes of the packages.

Alternatively, based on detected demand for a package (e.g., based on inventory reservations), the inventory planning system can automatically prioritize overlapping packages within the inventory database. Based on the prioritization of packages within the inventory database, the inventory planning system manages the overlap impression inventory between overlapping packages to maintain inventory data integrity within the inventory database. For instance, in some embodiments, the inventory planning system assigns the overlap impression inventory between overlapping packages to the higher prioritized package, thus causing the inventory planning system to assign overlap impression inventory to the highest valued package (e.g., based on demand, the worth of package attributes, or another metric). In particular, the inventory planning system can re-segment the impression inventory within the inventory database based on both the attributes of the overlapping packages and the respective assigned priorities of the overlapping packages.

Because the inventory planning system prioritizes overlapping packages, and assigns overlap impression inventory to packages within the inventory database based on the prioritization, the inventory planning system accurately maximizes impression inventory usage. In the first instance, based on prioritizing overlapping packages, the inventory management system allocates each impression in the impression inventory to a single package within the inventory database, thus preventing the overbooking of packages due to double-counting inventory in multiple overlapping packages. In addition, due to prioritizing overlapping packages, the inventory management system minimizes the undervaluing of impression inventory by preventing the booking of overlap impressions through a lesser valued package.

In some cases, overlapping packages can be assigned the same priority. In such cases, the inventory planning system adjusts impression inventories within packages in real-time (or near real-time) based on receiving an inventory reservation request from a third-party provider system for an overlapping package. For example, a package can include an overall inventory of impressions that is a combination of overlap impressions and exclusive impressions (i.e., impressions that do not overlap other packages). For instance, a segment within the inventory database representing the package may include impressions that fall only within the segment and impressions that fall within the segment in addition to another segment of another package within the inventory database. Furthermore, based on receiving an inventory reservation request from a third-party provider system, the inventory planning system adjusts exclusive impression inventory and/or overlap impression inventory. In particular, utilizing a specialized algorithm, based on receiving an inventory reservation request from the third-party provider system, the inventory planning system can adjust a number of exclusive impressions assigned to the package and a number of overlap impressions assigned to the package within the inventory database.

In one or more embodiments, for example, upon receiving an inventory reservation request from the third-party provider system for a given overlapping package, the inventory planning system queries the inventory database to determine whether the given package includes enough available exclusive impressions assigned to the given package within the inventory database to satisfy the reservation request. If, on one hand, the inventory planning system determines that the available exclusive impressions assigned to the given package within the inventory database do satisfy the reservation request, the inventory planning system reserves and deducts the number of impressions within the inventory reservation request from the exclusive impressions of the given package. For instance, the inventory planning system can remove the number of impressions from a segment within the impression inventory of the inventory database representing the given package. Furthermore, the inventory planning system adjusts, within the inventory database, the overall inventory for the given package (i.e., the segment representing the given package) by the amount of exclusive impressions reserved.

On the other hand, if the inventory planning system queries the inventory database and determines that the available exclusive impressions assigned to the given package within the inventory database do not satisfy the reservation request, the inventory planning system exhausts any available exclusive impressions of the given package (i.e., removes the exclusive impressions from and/or marks the exclusive impressions as reserved within the inventory database). Additionally, the inventory planning system queries the inventory database and determines whether the given package includes enough available overlap impressions assigned to the given package within the inventory database to satisfy the reservation request and then reserves the remaining impressions of the inventory reservation request from the overlap impressions within the inventory database. Based on the inventory planning system reserving overlap impressions, the inventory planning system adjusts the overall inventory of the given package for which the inventory reservation was received, as well as the overall inventory of all other overlapping packages that previously shared the now-reserved overlap impressions. In particular, as noted briefly above, based on receiving the inventory reservation request from the third-party provider system, the inventory planning system utilizes a specialized algorithm to adjust a number of exclusive impressions assigned to the package, a number of overlap impressions assigned to the package within the inventory database, as well as the overall inventory of all other overlapping packages that previously shared the now-reserved overlap impressions.

Because the inventory planning system adjusts the overall inventory of multiple overlapping packages based on an inventory reservation request made against one package, the inventory planning system accurately and efficiently adjusts available inventory for each of the multiple overlapping packages (e.g., accurately and efficiently re-segments and adjusts assignments of the impression inventory within the inventory database). Accordingly, the inventory planning system prevents overbooking impressions that are included within multiple overlapping packages of the same priority by maintaining accurate and real-time defined segments and assignments of impression inventory within the inventory database. Furthermore, the inventory planning system can maximize use of valuable overlap impressions by ensuring that overlap impressions within a higher valued package are only reserved within a lower valued package only if the lower valued package has exhausted all other available inventory options (e.g., exclusive inventory, or less valuable overlap inventory).

Furthermore, because the inventory planning system of the present disclosure prevents overbooking of packages and maintains real-time inventory availability of impressions packages within the inventory database (i.e., real-time defined segment and assignments), the inventory planning system provides improvements in the performance of a computer system. For example, because the inventory planning system prevents overbooking packages, the inventory planning system prevents redundant inventory reservation requests, and as a result, reduces consumption of processing power, memory, and storage. Therefore, the inventory planning system reduces required processing, memory and storage, and communication resources needed to manage packages. Furthermore, and in contrast to conventional systems, the inventory planning system maintains real-time impression inventory information for packages, which further reduces required processing, memory and storage, and communication resources to reconcile overbooked packages.

As used herein, the terms “publisher content” or “content” refers to media content that a publisher provides to an audience via a user device associated with each member of the audience (e.g., a television, computing device, mobile device). For example, publisher content can include audio content, video content, or other forms of digital media. For instance, publisher content can take the form of a television series and/or show, an Internet series and/or show, Internet channel, a movie, a news program, a special event, a sporting event, digital radio, a podcast, user-generated content, and/or any other presentation forms or genres of media. In one or more embodiments, publisher content can include content provided via broadcast satellite networks, cable networks, and/or Internet networks. In many cases, publisher content includes digital media streams and/or downloadable video media files.

Relatedly, and as used herein, the term “publisher” refers to a provider of content to an audience. For example, the term “publisher” may refer to television networks, cable companies, internet streaming services, internet content aggregators, radio networks, internet advertisements, etc.

As used herein, the term “impression” refers to an anticipated or forecasted interaction with publisher content by an audience member via a user device. For example, an audience member interaction with publisher content can include viewing content, listening to content, and/or otherwise participating in a presentation of content via a user device. Furthermore, publisher content can be designed to provide multiple interaction opportunities to an audience member during the presentation of the content based on defined impression opportunities (e.g., ad slots) within publisher content.

In addition, an impression can be defined based on various attributes. As used herein, “attributes” refer to characteristics or properties of users, content, devices, time, location, and/or other factors that describe or can correspond audiences members, content, including, but not limited to, audience member attributes (e.g., age group, gender, denomination, demographics, etc.), content attributes (e.g., specific content, content genre, content duration, content rating, series name, etc.), device attributes (user device type), geography attributes (e.g., country, state, and/or city), time attributes (e.g., time of day and/or day of week) publisher attributes (e.g., type of publisher), and/or point of delivery (“POD”) details.

As used herein, the term “impression inventory” refers to an amount of available impressions corresponding to one or more defined attributes. In some embodiments, impression inventory is based on historical analytics data of previously provided content. For example, an analytics system can accurately predict an amount of unique audience member interactions that will result from providing publisher content, and thus, an amount of available impressions (i.e., impression inventory).

As used herein, the term “package” (or simply “package”) refers to an impression definition based on one or more attributes that create a subset of impressions from the impression inventory. For example, based on the impression definition, a package be associated with an impression inventory that includes impressions correlating to the one or more impression attributes. In particular, based on the impression definition, a package can refer to a defined segment of impressions that correlate to the one or more impression attributes within an impression inventory of an inventory database. In one or more embodiments, a publisher and/or third party (e.g., advertiser) can create a package utilizing a user device by selecting or otherwise defining attributes for the package within a user interface of the inventory planning system. In other embodiments, the inventory planning system can automatically generate a package based on determining combinations of attributes that may be in demand according to an analysis of historical analytic data.

Relatedly, the term “overlapping packages” or “overlapping packages” refers to packages having impression definitions that create overlap impressions. For example, an overlapping package can refer to a defined segment of impressions within an impression inventory of an inventory database that at least partially overlaps with another defined segment of impressions of the impression inventory representing another package. Furthermore, as used herein, an “overlap impression” refers to an impression that correlates to two or more packages. For instance, an overlap impression refers to an impression that falls within two or more segments of impressions within the impression inventory that represent two or more packages.

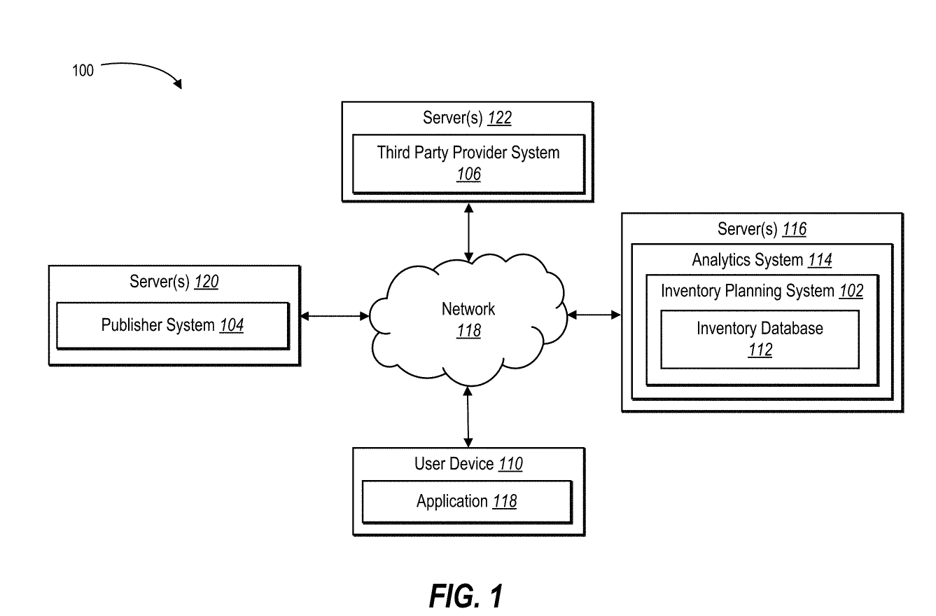

FIG. 1 illustrates a schematic diagram of an environment 100 in which an inventory planning system 102 can operate according to one or more embodiments of the present disclosure. In one or more embodiments, the inventory planning system 102 operates within, or in conjunction with, an analytics system 114 on one or more servers 116.

In addition to the inventory planning system 102, FIG. 1 illustrates that the environment 100 includes a publisher system 104 (on server(s) 120), a third-party provider system 106 (on server(s) 122), a network 108, and a user device 110 having an application 118. The inventory planning system 102, the analytics system 114, the publisher system 104, the third-party provider system 106, and the user device 110 can communicate via the network 108.

The network 108 may include one or more networks, such as the Internet, and may use one or more communications platforms or technologies suitable for transmitting data and/or communication signals. Although FIG. 1 illustrates a particular arrangement of the inventory planning system 102, the publisher system 104, the third-party content provider 106, the user device 110, the network 108, and servers 116, 120, 122, various additional arrangements are possible. For example, the publisher system 104 may directly communicate with the inventory planning system 102, bypassing the network 108. In alternative embodiments, the inventory planning system 102 can be included within the publisher system 104. For example, the inventory planning system 102 can include a software product within the publisher system 104 that interfaces with content providing software products within the publisher system 104.

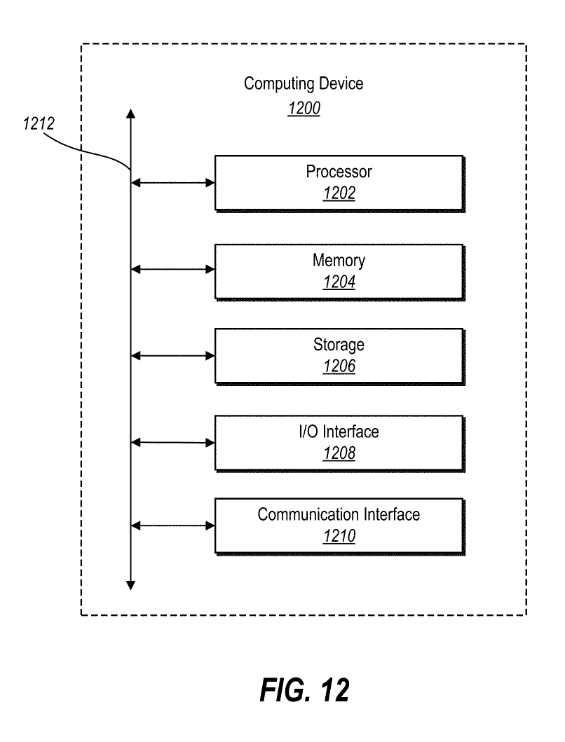

As further illustrated in FIG. 1, the inventory planning system 102, publisher system 104, and third-party provider system can be located on servers 116, 120, 122, respectively. Servers 116, 120, and 122 may include computing devices, such as non-mobile computing devices such as a desktop computer, or one or more servers. Additionally, application 118 can be located on user device 110. User device 110 represents various types of computing devices with which users may interact. For example, the user device 110 is a digital television. Alternatively, the user device 110 is a computing device, such as a desktop or laptop computer. Other examples of the user device 110 include a mobile device, such as a cell phone, a smartphone, a PDA, a tablet, a watch, a wearable device, etc. Additional details with respect computing devices are discussed below with respect to FIG. 12.

The publisher system 104 can generate and/or create publisher content to provide to the user device 110 for presentation to a user. For example, the publisher system 104 can stream, download, or otherwise communicate publisher content to the user device 110 (e.g., via network 108). In one or more embodiments, the publisher system 104 can provide publisher content via application 118 located on the user device 110. Examples of application 118 include an Internet browser, a native media presentation application, a publisher specific application, or any other application that causes the user device 110 to present publisher content to a user.

The inventory planning system 102 manages impression inventory within publisher content. For example, the inventory planning system 102 allocates impression inventory to publisher content to allow the publisher system 104 to add third-party content from the third-party provider system 106 in conjunction with providing publisher content. For example, publisher content can have specified ad slots (e.g., commercial breaks), prior to, within, or after a presentation of publisher content. A third-party can access the inventory planning system 102, via the third-party provider system for example, to reserve impression inventory associated with publisher content.

Based on receiving an inventory reservation, the inventory planning system 102 communicates the reserved impression inventory to the publisher system 104, and the publisher system provides third-party content within publisher content in accordance with the reserved impressions. Examples of third-party content can include advertisements, announcements, broadcasts, commercials, trailers, endorsements, publications, etc. In some embodiments, the third-party system 106 provides third-party content to the publisher system 104, and the publisher system 104 inserts the third-party content within the publisher content.

Alternatively, during a presentation of publisher content on user device 110, the publisher system 104 can provide, within the published content, a content request that identifies a location of third-party. The content request causes the application 118 on the user device 110 to request and receive third-party content from third-party provider system 106. In yet additional embodiments, the analytics system 114 monitors a presentation of publisher content on user device 110, and based on the third-party reservation of inventory, the analytics system 114 provides, or causes the third-party provider system 106 to provide, the third-party content. In one or more embodiments, the third-party content is one or more of video media and audio media.

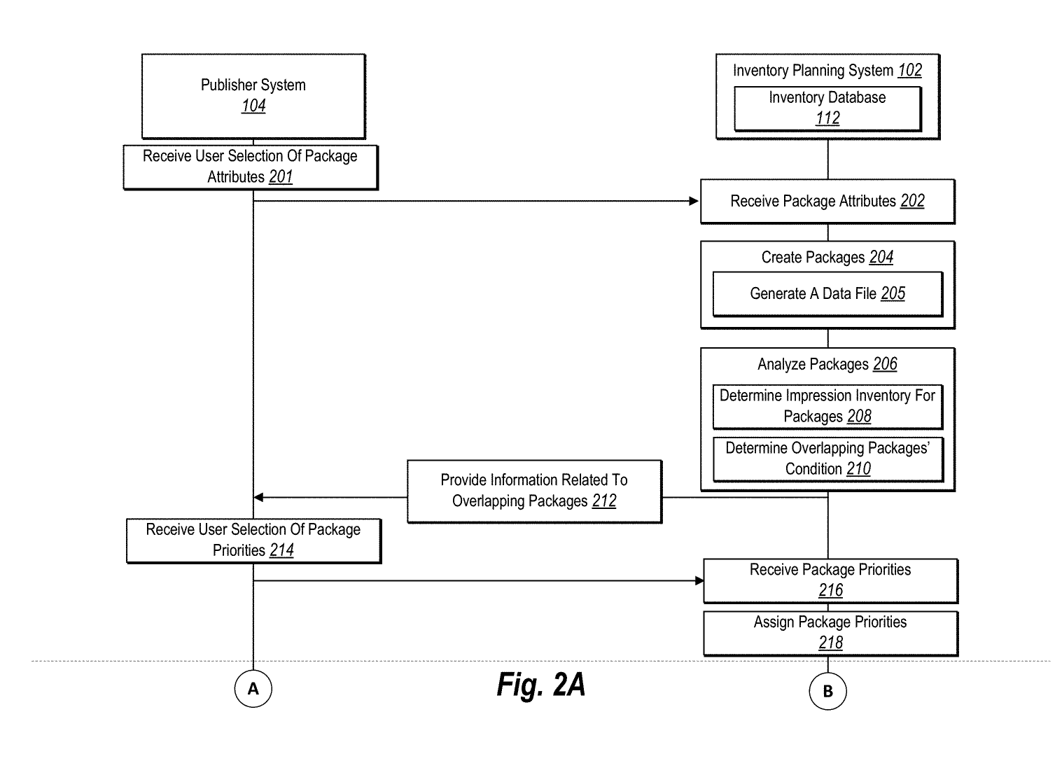

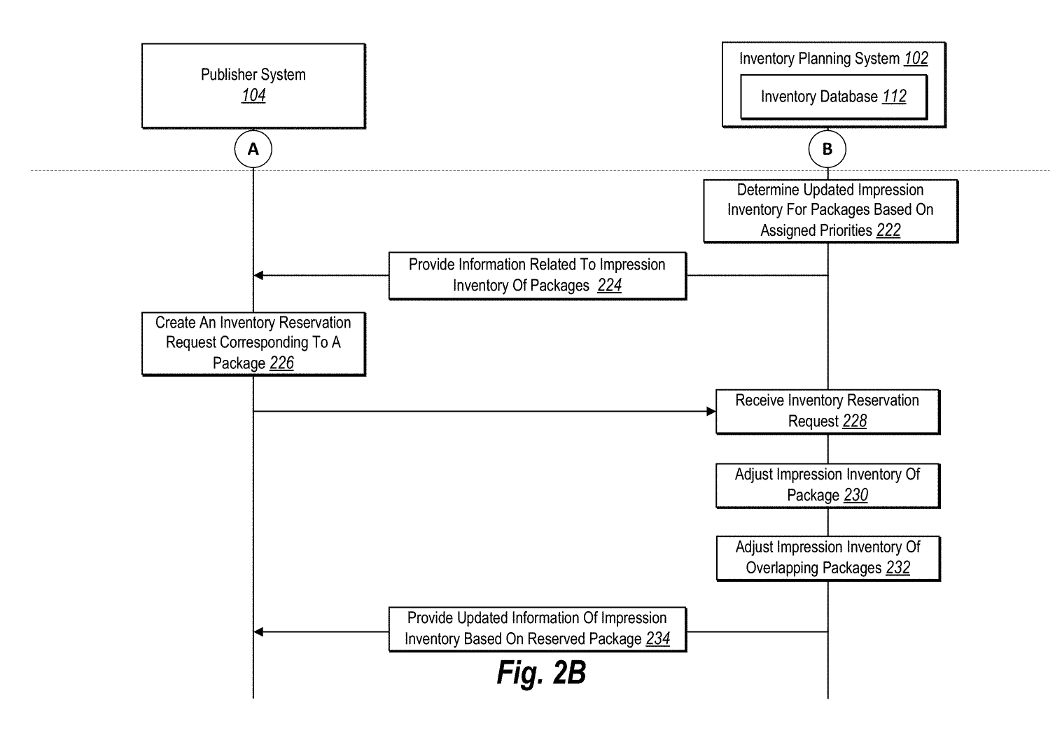

Furthermore, as is described in greater detail below in regard to FIGS. 2A and 2B, the publisher can use the inventory planning system 102 to create a package to categorize impression inventory based on various user-selected or system-selected attributes (e.g., content, audience member, user device type, and other attributes as described herein). As further illustrated in FIG. 1, in some embodiments, the inventory planning system 102 includes an inventory database 112, which can include impression inventory data and package data. The impression inventory data may include an amount of time slots (e.g., impression opportunities) within publisher content, audience attribute data, time-based attribute data (e.g., anticipated time of day and/or day of week associated with impressions). The package data can include definitions for a package, or in other words, attributes that define a particular package.

In one or more embodiments, the analytics system 114 provides and/or generates the inventory data based on collecting historical analytic data from previous presentations of publisher content. For example, and as discussed above, the analytics system 114 can perform a computational analysis on collected analytic data to forecast or otherwise predict an amount of, and attributes associated with, impression inventory. Accordingly, based analytic data, the analytics system 114 can provide the inventory planning system 102 an impression inventory based on projected impressions.

FIGS. 2A-2B illustrate a sequence-flow diagram 200 that an inventory planning system 102 can utilize to determine and adjust impression inventory within overlapping packages. The inventory planning system 102 and publisher system 104 shown in FIGS. 2A and 2B may be example embodiments of the inventory planning system 102 and the publisher system 104 described in regard to FIG. 1. As will be described below, a publisher user of the publisher system 104 can access the inventory planning system 102 (e.g., via a software application or web browser). Accordingly, the publisher system 104 can provide the publisher user a graphical user interface with which the publisher user interacts to provide user input to, and receive inventory planning information from, the inventory planning system 102.

As illustrated in FIG. 2A, the publisher system 104 can receive user input indicating a selection of package attributes, as shown in act 201. In one or more embodiments, the available attributes are based on analytic data that an analytics system provides to the inventory planning system 102. For example, the publisher system 104 can provide a graphical user interface that includes a list of various available attributes to create a package. Specifically, the publisher system 104 can detect one or more user interactions with the graphical user interface indicating a selection of at least one package attribute that defines a package. Accordingly, the publisher user can create a package by selecting attributes that allow the inventory planning system 102 to generate an impression inventory that includes impressions that match the selected attributes.

Furthermore, using the same or similar process described above, a publisher user can create multiple packages. For instance, the publisher system 104 can receive user input indicating a request to create a first package, and in addition, receive user input indicating a first selection of package attributes to associate with the first package. The publisher can proceed to create a second package. For example, the publisher system 104 can receive user input indicating a request to create a second package, and in addition, receive user input indicating a second selection of package attributes to associate with the second package. Accordingly, a publisher user can define different attributes for each individual package individually.

Additionally, the inventory planning system 102 can receive the package attributes from the publisher system 104, as shown in act 202 illustrated in FIG. 2A. In some embodiments, the inventory planning system 102 can receive a data package that includes a request to create a package and the selected package attributes to apply to the package. For example, in response to detecting the user interaction selecting package attributes, the publisher system 104 can provide the data package to the inventory planning system 102.

Furthermore, although the inventory planning system 102 is described herein as receiving the package attributes from the publisher system 104, the disclosure is not so limited. For example, in one or more embodiments, the inventory planning system 102 can receive the package attributes directly from other systems, for example, the third-party content provider 106. For instance, in some embodiments, the publisher system 104 can give access of the inventory planning system 102 to other systems, such that, the other systems or parties can create custom packages having attributes specified by the other system or party.

Upon receiving the package attributes within a request to create a package, the inventory planning system 102 creates a package, as shown in act 204 of FIG. 2A. As will be understood based on the disclosure herein, the inventory planning system 102 can create a plurality of packages in response to receiving multiple package requests that each define package attributes. In one or more embodiments, for example, the inventory planning system 102 can create a first package and a second package. In additional embodiments, the inventory planning system 102 can create three or more packages (e.g., five packages, ten packages, twenty packages, etc.).

To create a package, the inventory planning system 102 can generate a data file that stores the attributes associated with the package, as shown in act 205 of FIG. 2A. In addition, and as will be described further in the below acts, the data file can further include a data table that defines an impression inventory for each package, where the impression inventory references impressions that correspond to the attributes associated with the package. Furthermore, the inventory planning system 102 can store the data file defining the package within the inventory database 112.

In addition to creating the one or more packages, the inventory planning system 102 analyzes the plurality of packages with respect to a total available impression inventory (e.g., all available impressions regardless of attribute) within the inventory database 112, as shown in act 206 of FIG. 2A. As further shown in act 208 of FIG. 2A, the inventory planning system 102 analyzes the plurality of packages to determine an impression inventory for each package of the plurality of packages, as shown in act 208 of FIG. 2A. For example, based on the attributes associated with a given package, the inventory planning system 102 determines which impressions within the total available impression inventory match the attributes of the given package.

In some embodiments, to determine an impression inventory for a package, the inventory planning system 102 queries the inventory database 112 to determine impressions that match the attributes of the package. For instance, the inventory planning system 102 can compare attributes of the package with data associated with impressions within the total available impression inventory. In particular, the inventory planning system 102 can compare attributes of a package to data within an impression data table that includes attribute data describing impressions within the total available impression inventory to determine matching impressions. Accordingly, in response to querying the inventory database 112, the inventory planning system 102 can locate a set of impressions that are assigned to the impression inventory of the package.

In some embodiments, the inventory planning system 102 can characterize the determined impression inventory for a package in daily, weekly, and/or monthly allotments. For example, the determined impression inventory of the given package can include a plurality of available segments of inventory (e.g., impressions) dispersed throughout a period of days, weeks, and/or months. For instance, the impression inventory of a package can include a culmination of daily, weekly, and/or monthly inventory for a package. In addition, characterizing an impression inventory for a package can include categorizing impressions based on one or more impression attributes, generating a demand curve for impressions within the impression inventory, and/or other analysis with respect to the impression inventory.

Based on determining an impression inventory for each of the plurality of packages, and as shown in act 210 of FIG. 2A, the inventory planning system 102 determines whether an overlapping packages condition exists. An overlapping packages condition exists when a first impression inventory of a first package includes impressions that are also included in a second impression inventory of a second package. Accordingly, and as used herein, the term “overlap” refers to a set of impressions that fall within two or more impression inventories of two or more packages, or in other words, overlap refers to impressions having attributes that match the attribute definition of two or more packages.

As a non-limiting example, a discrete individual impression can be associated with multiple attributes: females; ages 25-30; and comedy. In such as case, a first package can be defined by attributes: females; and ages 25-30, while a second package can be defined by attributes: ages 25-30; and comedy. In this case, the discrete individual impression has attributes that match the attributes of both the first package and the second package. As such, the discrete individual impression is an overlap impression and will be considered part of the overlap between the first package and the second package.

As a result of the foregoing, the inventory planning system 102 can determine and define exclusive impressions and overlap impressions for the impression inventory of each package. As used herein, the term “exclusive impressions” refer to impressions that have attributes that match only a single package. For example, exclusive impressions of a first package of the plurality of packages only match the attribute definition of the first package, and do not match the attribute definitions of the remaining packages of the plurality of packages. In addition, the term “overall inventory” refers to a combination of exclusive impressions within a given package and overlap impressions within a given package.

As a non-limiting example, when defining an overall inventory for a first package overlapping with a second package, the inventory planning system 102 can define the overall impression inventory of the first package as including a set of exclusive impressions for the first package, and a set of overlap impressions (e.g., impressions that are also included in the second package). Furthermore, the inventory planning system 102 can define the overall inventory of the second package as including a set of exclusive impressions for the second package, and a set of overlap impressions (e.g., impressions that are also included in the first package).

Referring to acts 204-210 of FIG. 2A together, although the inventory planning system 102 is described herein as performing each of these acts separately, the disclosure is not so limited. For example, in some embodiments, the inventory planning system 102 can perform each of the acts 204-210 together or in different orders. For instance, while the inventory planning system 102 creates the plurality of packages, the inventory planning system 102 can determine the impression inventory and overlap of the plurality of packages.

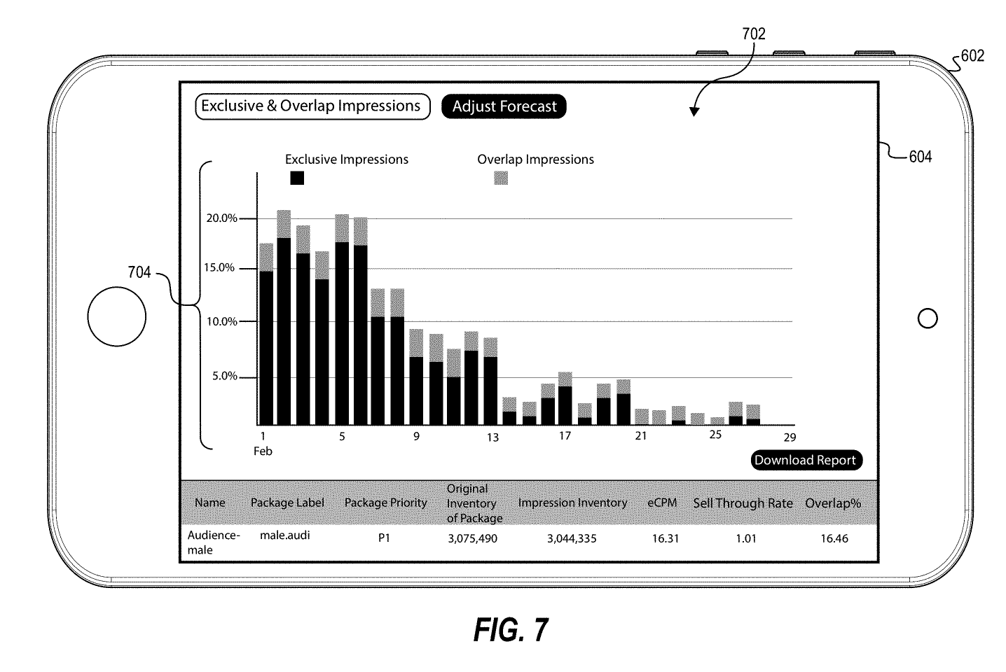

In addition to analyzing the plurality of packages, as illustrated in FIG. 2A, the inventory planning system 102 provides information (e.g., data) related to overlapping packages to the publisher system 104, as shown in act 212. For example, the inventory planning system 102 can provide information related to the impression inventory and the overlap of each package of the plurality of packages. In some embodiments, the inventory planning system 102 can provide information related to a number of exclusive impressions and a number of overlap impressions within an impression inventory of each package of the plurality of packages. Furthermore, the inventory planning system 102 can provide information related to which packages of the plurality of packages overlap with each other, and percentages of overlap of the overlapping packages. Providing the information related to the impression inventory and overlap to the publisher system 104 is described in further detail in regard to FIG. 7.

Upon receiving the information related to the impression inventory and overlap of each of the plurality of packages, the publisher system 104 can provide a prompt to the publisher user to prioritize packages, and in particular, to prioritize overlapping packages. In response to the prompt, the publisher user can provide input indicating a priority for one or more packages. For example, the publisher system detects a user interaction indicating a user selection of package priorities for the plurality of packages, as shown in step 214 of FIG. 2A.

As used herein, the term “priority” and any derivative terms, when used in reference to a digital package, means a relative ranking or importance of a package with respect to one or more packages. For example, given three packages, the packages can be assigned priorities P1, P2, or P3. In additional embodiments, the priorities of the plurality of packages can be numbers on a scale (e.g., a scale from P1 to P10 with P1 being the highest priority). Furthermore, in some embodiments, a publisher can assign multiple packages the same priority. For example, a first package of the plurality of packages can have a priority of P1, and a second package of the plurality of packages can also have a priority of P1.

In response to detecting the user interaction selecting the priorities of the plurality of packages at the publisher system 104, the inventory planning system 102 can receive the priorities of the plurality of packages, as shown in act 216 of FIG. 2A. In some embodiments, the inventory planning system 102 can receive a data package indicating the selected priorities for each package of the plurality of packages. For example, in response to detecting the user interaction selecting priorities of the plurality of packages, the publisher system 104 can provide the priorities of the plurality of packages to the inventory planning system 102.

Although the priorities of the plurality of packages are described herein as being selected and received after the plurality of packages are created, the disclosure is not so limited. For example, the publisher system 104 can detect the selection of priorities of the plurality of packages and the inventory planning system 102 can receive the priorities of the plurality of packages during acts 201 and 202 of FIG. 2A. For instance, in some embodiments, the inventory planning system 102 can receive the priorities of the plurality of packages when the inventory planning system 102 receives the attributes of the plurality of packages.

Additionally, in some embodiments, the publisher system 104 can assign priorities automatically. For instance, the publisher system 104 can assign priorities of the plurality of packages based on demand history of the plurality of packages. For example, the publisher system 104 can assign packages of the plurality of packages having higher demand histories with higher priorities. In further embodiments, the publisher system 104 can assign priorities of the plurality of packages based on price settings of the publisher. In particular, the publisher system 104 can assign packages having higher prices with higher priorities.

In response to receiving the priorities of the plurality of packages, the inventory planning system 102 assigns the priorities to the respective packages, as shown in act 218 of FIG. 2A. For example, the inventory planning system 102 can assign each data package a priority based on its respective received priority. Furthermore, the inventory planning system 102 can store data representing the received priority within the inventory database 112, for instance, within a data file corresponding to a given package.

Upon assigning the received priorities to the plurality of packages, the inventory planning system 102 determines an updated impression inventory of overlapping packages based on the assigned priorities, as shown in act 222 of FIG. 2A. For example, the inventory planning system 102 can compare the assigned priority for each of the overlapping packages to determine an updated impression inventory for each of the overlapping packages. In particular, for overlapping packages that each have a different priority, the inventory planning system 102 assigns the overlap (e.g., all the overlap impressions) to the package having the higher priority. For instance, given a first package that overlaps with a second package, and where the first package has a higher priority than the second package, the inventory planning system 102 assigns the overlap between the first package and the second package to the overall inventory of first package. On the other hand, the inventory planning system 102 removes the overlap impressions from the overall inventory of the second package.

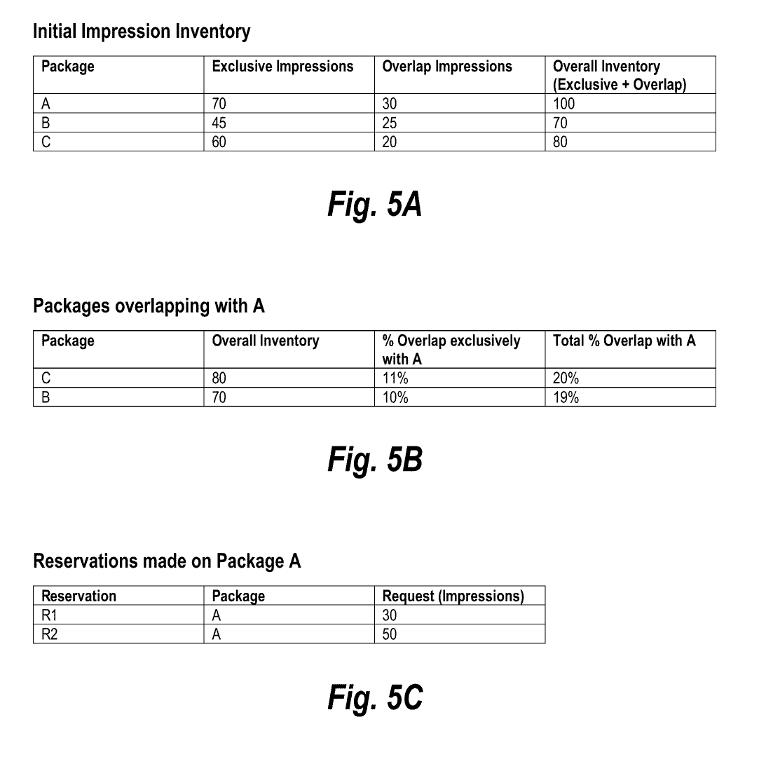

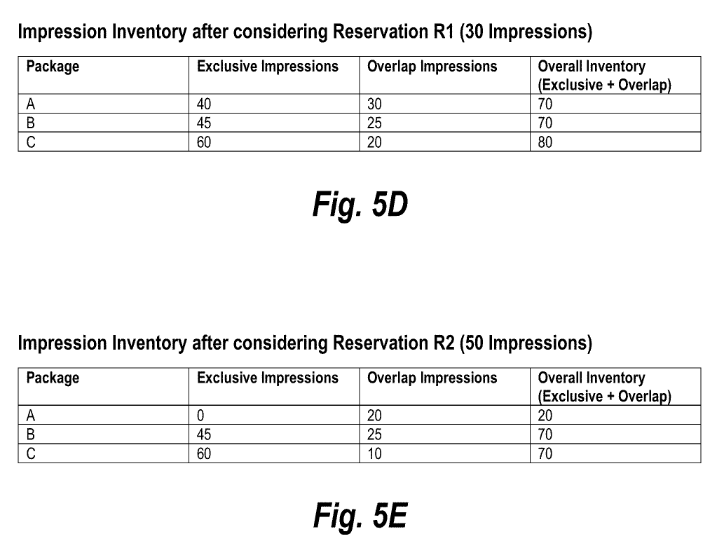

As also mentioned briefly above, in additional embodiments, the inventory planning system 102 can determine the impression inventory of overlapping packages having the same priority. In particular, for overlapping packages having the same priority, the inventory planning system 102 initially assigns any overlap (e.g., overlap impressions) to the overall inventory of each package within the overlapping packages. For instance, given a first package overlapping with a second package, and where the first package has the same priority as the second package, the inventory planning system 102 initially assigns the overlap to the overall inventory of first package and to the overall inventory of the second package. Then, and as is described in greater detail below with regard to FIGS. 5A-5E, the inventory planning system updates the overall inventory of the first package and the overall inventory of the second package in response to receiving an inventory reservation request that reserves overlap impressions.

Based on determining an impression inventory for each package within the overlapping packages, the inventory planning system 102 provides information related to the impression inventory for each of the plurality of packages, as shown in act 224d of FIG. 2B. In one or more embodiments, the inventory planning system 102 can provide a quantity of overall inventory for each package. In the same or other embodiments, the inventory planning system 102 can provide information related to a number of available exclusive impressions and a number of available overlap impressions of each package of overlapping packages. Furthermore, the inventory planning system 102 can provide information related to packages having the same priority, such as percentages of overlap between overlapping packages and/or number of overlap impressions. Providing the information related to the impression inventory and overlap of the packages to the publisher system 104 is described in further detail in regard to FIG. 7.

Still referring to FIGS. 2A and 2B, although the inventory planning system 102 is described herein as providing some information in act 212 and additional information in act 224, in some embodiments, the inventory planning system 102 can provide all the information described in regard to acts 212 and 224 of FIGS. 2A and 2B together in a single step.

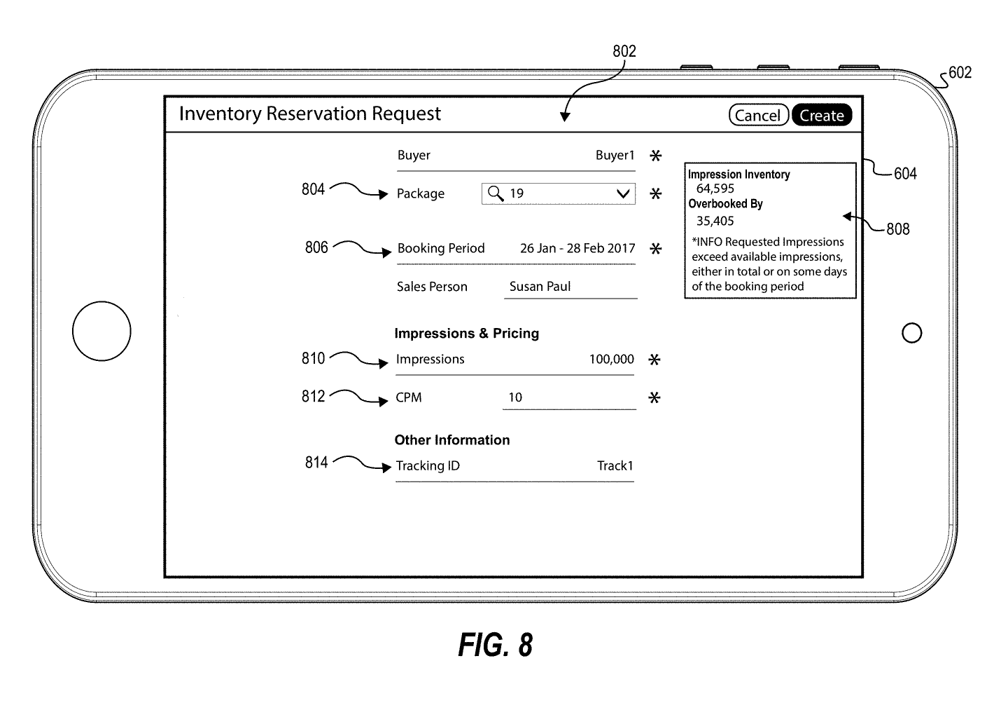

In response to the inventory planning system providing information related to the impression inventory of the packages, the publisher system 104 can receive user input (e.g., in response to detecting a user interaction) to create an inventory reservation request (e.g., a booking of impressions) of at least a portion of impression inventory of a package, as shown in act 226 of FIG. 2B. For instance, in some embodiments, the publisher system 104 can receive an inventory reservation request from a third party (i.e., third-party provider system), and, in response to receiving the inventory reservation request from the third party, the publisher system 104 can provide the inventory reservation request to the inventory planning system 102. Furthermore, and as is discussed in greater detail below in regard to FIG. 8, when creating an inventory reservation request, a user of the publisher system 104 can select a package and an amount of impressions to reserve from the impression inventory for the selected package. In alternative embodiments, the third-party provider system can provide the inventory reservation request directly to the inventory planning system 102.

The inventory planning system can receive the inventory reservation request, as shown in act 228 of FIG. 2B. In some embodiments, the inventory planning system 102 can receive a data package indicating the inventory reservation request corresponding to a package. As used herein, the term “primary package” refers to the package corresponding to an inventory reservation request. Upon receiving the inventory reservation request from the publisher system 104, the inventory planning system 102 adjusts the impression inventory of the primary package, as shown in act 230 of FIG. 2B.

For example, in the event the inventory reservation request corresponds to a package having a unique priority, the inventory planning system 102 assigns previously allocated overlap impressions to either the primary package, or to another package, depending on whether the primary package had a higher or lower priority than the other package. In such a case, due to the unique priority of either the primary package or the other package, one package having a higher priority than another package, and the overlap impressions being pre-allocated, the inventory planning system adjusts (i.e., reduces) the overall impression inventory in an amount equal to an amount of requested impressions of the inventory reservation request.

Alternatively, in the case where the inventory reservation request corresponds to a primary package that overlaps another package of equal priority, the inventory planning system adjusts the impression inventory for the primary package by generally performing three acts: 1) determining an amount of exclusive impressions within the primary package to reserve; 2) determining an amount of overlap impressions within the primary package to reserve; and 3) adjusting the exclusive impressions, the overlap impressions, and thus, the overall impression inventory of the primary package.

To determine an amount of exclusive impressions to reserve, the inventory planning system 102 determines whether an amount of exclusive impressions will satisfy the reservation request. If the amount of exclusive impressions can satisfy the inventory reservation request, the inventory planning system 102 deducts the amount of impressions included in the reservation request (e.g., the number of reserved impressions) from the exclusive impressions of the primary package, and thereby, reduces not only the exclusive impression inventory, but also the overall inventory of the primary package.

If, on the other hand, the inventory planning system 102 determines that the available exclusive impressions of the primary package do not satisfy the inventory reservation request, the inventory planning system 102 can exhaust the any available exclusive impressions within the impression inventory of the primary package, and then deduct a remaining demand of impressions from overlap impressions of the primary package. In such a case, the inventory planning system reduces the exclusive impression inventory to zero, the overlap impression inventory by the amount of the remaining demand, and the overall impression inventory by the amount of the total impressions reserved (e.g., the sum of the exclusive impressions and overlap impressions reserved).

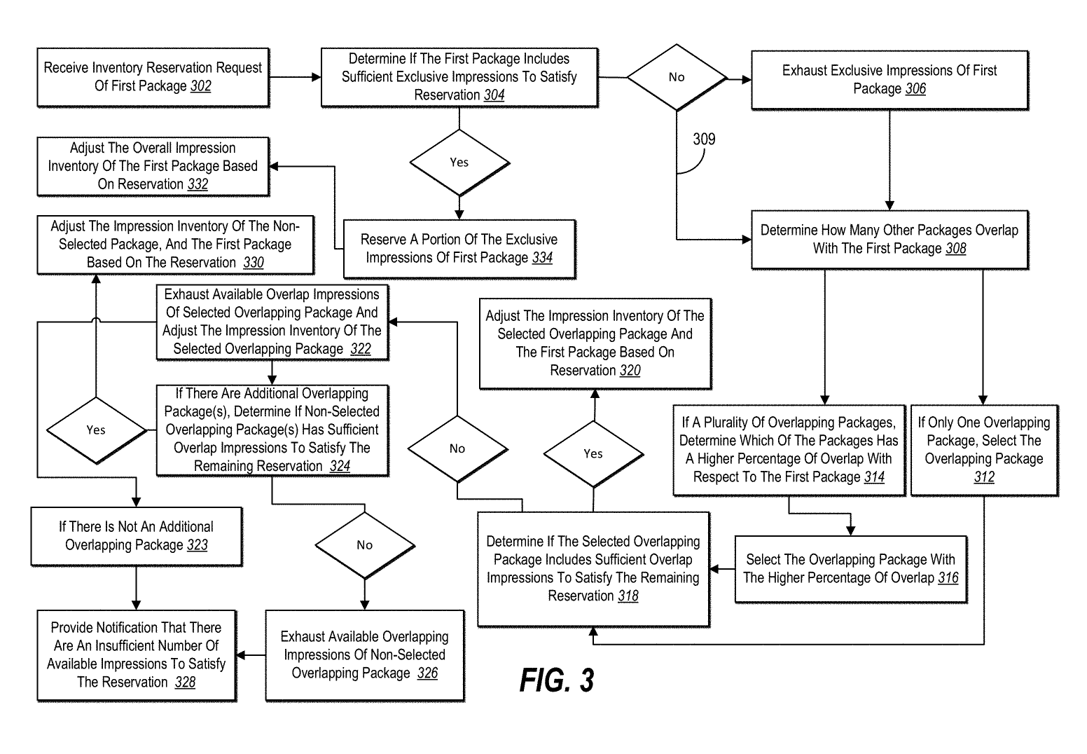

In addition to the impression inventory of the primary package, the inventory planning system 102 also adjusts the impression inventory of the overlapping package(s) that overlap the primary package, as shown in act 232 of FIG. 2B. For example, the inventory planning system 102 can adjust the overall impression inventory of the overlapping package(s) by the amount of overlap impressions that were deducted to satisfy the inventory reservation request for the primary package. Additional details of adjusting the impression inventory of the overlapping packages is discussed in greater detail below in regard to FIG. 3.

Upon adjusting the impression inventory of overlapping packages, the inventory planning system 102 provides updated information on remaining available inventory (e.g., the impression inventory of the primary package and the overlapping package(s)) to the publisher system 104, as shown in act 234 of FIG. 2B. For example, the inventory planning system 102 can provide updated information related to the impression inventory of each package of the plurality of packages based on the adjustments described in acts 230 and 232 of FIG. 2B. For instance, the inventory planning system 102 can provide updated information related to a number of exclusive impressions, a number of available overlap impressions, and a total number of the overall impression inventory of each package of the plurality of packages.

As mentioned, FIG. 3 illustrates a diagram of an algorithm for adjusting overall availabilities of overlapping packages having the same priority based on an inventory reservation request. In particular, FIG. 3 illustrates performing a step for 300 adjusting, based on the inventory reservation request of a first package, the overall impression inventory of at least one overlapping package (i.e., a second package) according to one or more embodiments of the present disclosure. Furthermore, the step for 300 can include any of the actions described below in regard to boxes 302-334.

As illustrated in box 302 of FIG. 3, the step 300 includes receiving an inventory reservation request of a first package. In particular, the inventory planning system 102 can receive an inventory reservation request for impression inventory within a first package from among a plurality of packages (i.e., a first package, a second package, and a third package). As discussed above, the inventory reservation request can result in booking an amount of impressions from the first package. For example, step 300 can include any of the actions describe above in regard to act 228 of FIG. 2B.

Additionally, the step 300 includes determining whether the first package includes sufficient exclusive impressions to satisfy the inventory reservation request, as shown in box 304 of FIG. 3. As used herein, the terms “sufficient amount” when used in regard to impressions refer to an amount of impressions greater than or equal to a required amount impressions of the inventory reservation request or a remaining required amount of impressions of the inventory reservation request after the inventory reservation request has been partially fulfilled. For example, the inventory planning system 102 queries the inventory database 112 and determines a number of exclusive impressions of the first package and determines whether the number of exclusive impressions of the first package satisfies the inventory reservation request (e.g., compares the number of required impressions in the inventory reservation request and the number of exclusive impressions of the first package). Furthermore, the step 300 can include any of the actions described above in regard to act 230 of FIG. 2B.

If the inventory planning system 102 determines that the first package does include sufficient exclusive impressions to satisfy the inventory reservation request, the step 300 includes reserving at least a portion of the exclusive impressions of the first package to satisfy the inventory reservation request, as shown in box 334 of FIG. 3. For example, the inventory planning system 102 reserves a portion of the exclusive impressions of the first package.

Furthermore, in response to reserving a portion of the exclusive impressions of the first package to satisfy the inventory reservation request, the step 300 includes adjusting the overall impression inventory (e.g., the combination of the exclusive impressions and the overlap impressions) of the first package, as shown in box 332 of FIG. 3. In particular, the inventory planning system 102 reduces the overall impression inventory of the first package by subtracting from the overall impression inventory the number of required impressions of the inventory reservation request. For example, the step 300 can include any of the actions described above in regard to act 230 of FIG. 2B.

If, on the other hand, the inventory planning system 102 determines that the first package includes at least some exclusive impressions but does not include sufficient exclusive impressions to satisfy the inventory reservation request, the step 300 includes reserving all of (e.g., exhausting) the exclusive impressions of the first package, as shown in box 306 of FIG. 3. For example, the inventory planning system 102 reserves all of the exclusive impressions of the first package. Alternatively, if the inventory planning system 102 determines that the first package does not include any exclusive impressions, the step 300 bypasses reserving exclusive impressions of the first package as shown by line 309 and can include determining whether other packages overlap with the first package.

For instance, the step 300 includes determining how many additional packages (e.g., additional packages of the plurality of packages) overlap with the first package and have the same priority as the first package, as shown in box 308 of FIG. 3. For example, based on the analysis performed by the inventory planning system 102 in act 210 of FIG. 2A, the inventory planning system 102 identifies overlap (e.g., overlap impressions) between the first package and additional packages, and based on the overlap, the inventory planning system 102 can determine how many additional packages overlap with the first package.

If the inventory planning system 102 determines that there is only one additional overlapping package (e.g., the second package), the step 300 includes selecting the additional overlapping package (e.g., the second package), as shown in box 312. For example, as will be discussed in greater detail below, the inventory planning system 102 determines to reserve overlap impressions between the second package and the first package in an attempt to satisfy a remainder of the inventory reservation request.

If, on the other hand, the inventory planning system 102 determines that there is a plurality of additional overlapping packages (e.g., a second package and a third package), the step 300 includes determining which of the packages of the plurality of additional overlapping packages has a higher percentage of overlap with the first package with respect to the first package than a rest of the plurality of additional overlapping packages, as shown in box 314 of FIG. 3. For example, the step 300 can determine the percentage of overlap utilizing any of the actions described above in regard to act 210 of FIG. 2A.

If the inventory planning system 102 determines that one package of the plurality of additional overlapping packages has a higher percentage of overlap with the first package than the rest of the plurality of overlapping packages, the step 300 includes selecting the overlapping package with higher percentage of overlap, as shown in box 316 of FIG. 3. If, on the other hand, the inventory planning system 102 determines that two or more overlapping packages of the plurality of overlapping additional packages have a same higher percentage of overlap (e.g., each of the two or more overlapping packages has the same percentage of overlap) with the first package with respect to the first package, the step 300 can include selecting one of the two or more overlapping packages of the plurality of other packages. For example, in some embodiments, the inventory planning system 102 can include a random number generator and can select one of the two or more overlapping packages of the plurality of additional overlapping packages using the random number generator. In additional embodiments, the inventory planning system 102 can select one of the two or more overlapping packages of the plurality of other packages based on the values (e.g., prices) of the two or more overlapping packages. In particular, the inventory planning system 102 can select a package of the two or more overlapping packages having a lesser value such that the other packages (e.g., the impressions of the other packages) having higher values (e.g., sale price) are maintained. In alternative embodiments, the inventory planning system 102 can select a package of the two or more overlapping packages having a higher value such that the additional packages (e.g., the impressions of the other packages) having lesser values (e.g., sale price) are maintained. In yet further embodiments, the inventory planning system 102 can enable a user of the publisher system 104 to select (e.g., designate) a package of the two or more overlapping packages.

Furthermore, upon selecting an overlapping package (e.g., selecting an overlapping package as described in boxes 313 or 316), the step 300 includes determining whether there are a sufficient number of overlap impressions between the selected overlapping package and the first package to satisfy a remainder of the inventory reservation request (e.g., an amount of required impressions not satisfied with the exclusive impressions of the first package), as shown in box 318. For example, the inventory planning system 102 can query the inventory database 112 and can compare a number of remaining required impressions of the inventory reservation request (e.g., unfulfilled impressions) and the number of available overlap impressions between the selected overlapping package and the first package.

If the inventory planning system 102 determines that there are a sufficient number of overlap impressions between the selected overlapping package and the first package to satisfy the remainder of the inventory reservation request, the step 300 includes adjusting the impression inventory of the selected overlapping package and the first package based on the inventory reservation request, as shown in box 320 of FIG. 3. In particular, the inventory planning system 102 reduces the overall impression inventory of the selected overlapping package by subtracting, from the overall impression inventory of the selected overlapping package, the number of required impressions to satisfy the remainder of the inventory reservation request. For instance, the inventory planning system 102 subtracts the number of required impressions from the overlap impressions of the selected overlapping package with the first package. Furthermore, the inventory planning system 102 also further reduces the overall impression inventory of the first package, which has already been reduced in box 306 of FIG. 3, by subtracting from the overall impression inventory of the first package, the number of required impressions to satisfy the remainder of the inventory reservation request. Specifically, the inventory planning system 102 subtracts the number of required impressions from the overlap impressions of the first package with the selected package.

If, in the alternative, the inventory planning system 102 determines that there are not a sufficient number of overlap impressions between the selected overlapping package and the first package to satisfy a remainder of the inventory reservation request, the step 300 includes reserving (e.g., exhausting) all of the overlap impressions between the selected overlapping package and the first package and adjusting the impression inventory of the selected overlapping package, as shown in box 322 of FIG. 3. For example, the inventory planning system 102 reserves all of the overlap impressions between the selected overlapping package and the first package and adjusts the impression inventory of the selected overlapping package in the same manner described above in regard to box 320.

In addition to reserving all of the overlap impressions between the selected package and the first package, if there is an additional non-selected overlapping package (e.g., an overlapping package not selected in the action described in regard to boxes 314 and 316), the step 300 includes determining whether there are a sufficient number of overlap impressions between the non-selected overlapping package (e.g., the third package) and the first package to satisfy a remainder of the inventory reservation request (e.g., an amount of required impressions not satisfied with the exclusive impressions of the first package and the overlap impressions between the first package and the selected overlapping package), as shown in box 324. For example, the inventory planning system 102 compares a number of remaining required impressions in the inventory reservation request and the number of available overlap impressions between the non-selected overlapping package and the first package.

If the inventory planning system 102 determines that there are a sufficient number of overlap impressions between the non-selected overlapping package and the first package to satisfy the remainder of the inventory reservation request, the step 300 includes adjusting the impression inventory of the non-selected overlapping package and the first package based on the inventory reservation request, as shown in box 330 of FIG. 3. In particular, the inventory planning system 102 reduces the overall impression inventory of the non-selected overlapping package by subtracting the number of required impressions from the overall impression inventory of the non-selected overlapping package in order to satisfy the remainder of the inventory reservation request. For instance, the inventory planning system 102 subtracts the number of required impressions from the overlap impressions of the non-selected overlapping package with the first package. Furthermore, the inventory planning system 102 also further reduces the overall impression inventory of the first package, which has already been reduced by the actions described above in regard to boxes 306 and 322 of FIG. 3, by subtracting the number of required impressions from the overall impression inventory of the first package in order to satisfy the remainder of the inventory reservation request. Specifically, the inventory planning system 102 subtracts the number of required impressions from the overlap impressions of the first package with the non-selected overlapping package.

If, on the other hand, the inventory planning system 102 determines that there are not a sufficient number of overlap impressions between the non-selected overlapping package and the first package to satisfy a remainder of the inventory reservation request, the step 300 includes reserving (e.g., exhausting) all of the overlap impressions between non-selected overlapping package and first package, as shown in box 326 of FIG. 3. For example, the inventory planning system 102 reserves all of the overlap impressions between the non-selected package overlapping and the first package.

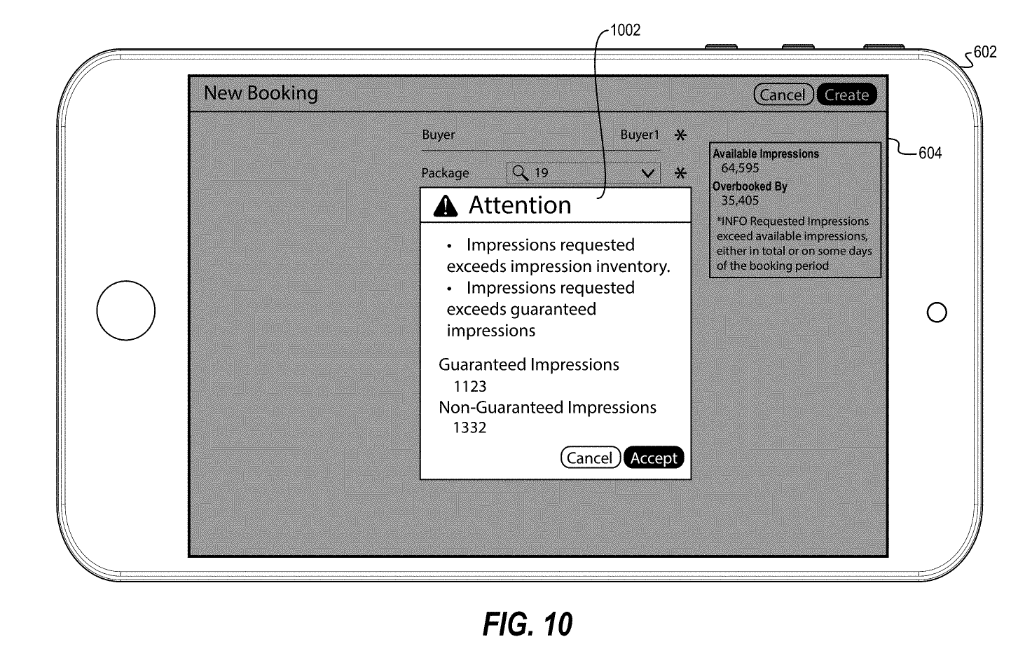

In addition to reserving all of the overlap impressions between the non-selected overlapping package and the first package, the step 300 includes providing a notification to the publisher system that there are an insufficient number of available impressions to satisfy the inventory reservation request, as shown in box 328. Providing a notification indicating that there is an insufficient number of available impressions to satisfy the inventory reservation requests is described in further detail in regard to FIG. 10.

Referring again to the actions described in regard to box 322, in addition to reserving all of the overlap impressions between the selected package and the first package, if there is not an additional non-selected overlapping package, the step 300 includes providing the notification to the publisher system that there are an insufficient number of available impressions to satisfy the inventory reservation request, as described above in regard to box 328.

Referring again to the actions described in regard to boxes 314 and 316, in some embodiments, the step 300 can include selecting each overlapping package (e.g., two or more packages). Furthermore, the inventory planning system 102 can reserve overlap impressions from each of the selected overlapping packages in order to satisfy the inventory reservation request. For example, in one or more embodiments, the inventory planning system 102 can reserve overlap impressions from each of the selected overlapping packages according to (e.g., proportional to or on a pro rata basis according to) their percentage overlap with the first package with respect to the first package.

Furthermore, although the step 300 is described herein in terms of only three packages (e.g., the first package, the second package, and the third package), the disclosure is not so limited. For example, the step 300 can include adjusting, based on the inventory reservation request of the first package, the overall impression inventory of any number of overlapping packages. For instance, the step 300 can repeat the actions described in regard to boxes 318, 322, and 324 for any number of additional overlapping packages in order to satisfy an inventory reservation request.

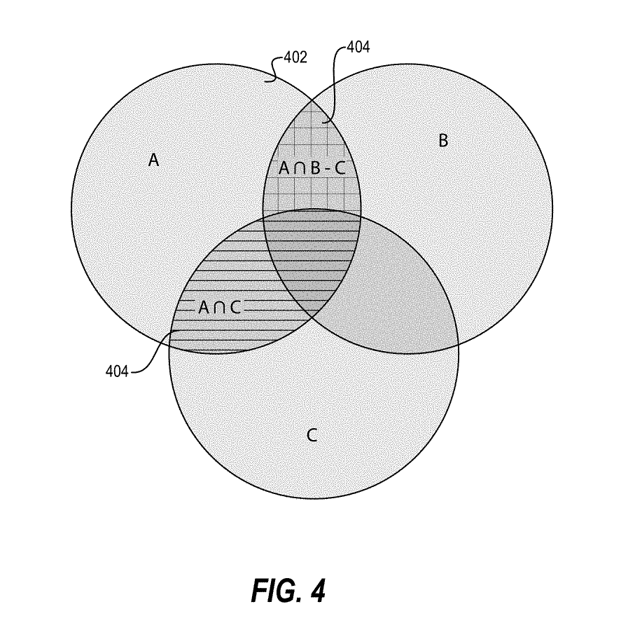

FIG. 4 illustrates a schematic representation of a plurality of packages created with the inventory planning system 102 according to one or more embodiments of the present disclosure. Additionally, FIGS. 5A-5E show example calculations and adjustments of overall availabilities of the plurality of packages of FIG. 4 based on a plurality of inventory reservation requests. Referring to FIGS. 4-5E together, the plurality of packages can include a package A, a package B, and a package C. Furthermore, as illustrated in FIG. 4, each package of the plurality of packages at least partially overlaps with the other packages of the plurality of packages. In particular, package A 402 includes overlap impressions 404 with package B (as indicated by the grid pattern), and package A includes overlap impressions 406 with package C (as indicated by the horizontal-line pattern).

As shown in FIG. 5A, initially (e.g., before any inventory reservation requests), package A includes 70 exclusive impressions and 30 overlap impressions (e.g., overlapping with packages B and C) resulting in an overall inventory of 100 impressions. Furthermore, package B includes 45 exclusive impressions and 25 overlap impressions (e.g., overlapping with packages A and C) resulting in an overall inventory of 70 impressions. Additionally, package C includes 60 exclusive impressions and 20 overlap impressions (e.g., overlapping with packages A and B) resulting in an overall inventory of 80 impressions. Moreover, for purposes of the embodiments described in regard to FIGS. 4-5E, the packages A, B, and C have the same priority.

FIG. 5A illustrates information with respect to packages that overlap with package A. For example, as shown in FIG. 5B, package B has a total overlap with package A of 19% with respect to package A (i.e., 19 impressions) and an exclusive overlap with package A (e.g., exclusive overlap includes only those impressions that overlap packages A and B, and not impressions that overlap with C) of 10% with respect to package A (i.e., 10 impressions). Moreover, package C has a total overlap with package A of 20% with respect to package A (i.e., 20 impressions) and an exclusive overlap with package A of 10% with respect to package A (i.e., 11 impressions).

FIG. 5C illustrates an example of an inventory reservation request. For instance, the inventory planning system 102 can receive an inventory reservation request as described above. For example, as shown in FIG. 5C, the inventory planning system 102 can receive a first reservation R1 of 30 impressions for package A, and a second reservation R2 of 50 impressions for package A. Furthermore, in response to receiving the first reservation R1, the inventory planning system 102 attempts to satisfy the first reservation R1 with available exclusive impressions of package A. As noted above, package A includes 70 exclusive impressions. As a result, the inventory planning system 102 reserves 30 impressions of the 70 exclusive impressions for the first reservation R1 and adjusts the overall impression inventory of package A, as shown in FIG. 5D.

For example, FIG. 5D shows the impression inventories of the packages A, B, and C, after receiving and fulfilling the first reservation R1. As shown, after fulfilling the first reservation R1, the package A now includes 40 exclusive impressions and an overall inventory of 70 impressions.

After satisfying the first reservation R1, the inventory planning system 102 attempts to satisfy the second reservation R2 of 50 impressions for package A. However, as noted above, package A now only includes 40 exclusive impressions after satisfying the first reservation R1. Accordingly, the inventory planning system 102 reserves the 40 exclusive impressions of package A, leaving 10 remaining impressions from the second reservation R2 unsatisfied.

As a result, the inventory planning system 102 deducts the remaining 10 impressions of the second reservation R2 from overlap impressions of an overlapping package. For example, as discussed above with respect to box 314 of FIG. 3, the inventory planning system 102 deducts the remaining 10 impressions from the overlapping package having a highest percentage of exclusive overlap with package A. In this case, the overlapping package having the highest percentage of exclusive overlap with package A is package C, because the percentage of exclusive overlap of package B is 14.3% (previously 10%) and the percentage of exclusive overlap of package C is 15.8% (previously 11%) after fulfilling the first reservation R1.

Accordingly, the inventory planning system 102 deducts the remaining 10 impressions from the overlap impressions within the overlap between package C and package A, and the inventory planning system 102 adjusts the overall availabilities of package C and package A accordingly, as shown in FIG. 5E. In particular, FIG. 5E shows the availabilities of the packages A, B, and C, after receiving and fulfilling the second reservation R2. As shown, after fulfilling the second reservation R1, the package A includes zero exclusive impressions and 20 overlap impressions (previously 30). In particular, the 20 overlap impressions of package A includes 1 impression overlapping with package C and 19 impressions overlapping with package B. Furthermore, package C includes 60 exclusive impressions and 10 available overlap impressions (previously 20 overlap impressions), for an overall inventory of 70 impressions.

In contrast to deducting all overlap impressions from package C as described above, in alternative embodiments, the inventory planning system 102 can deduct the remaining 10 impressions of the reservation request from both overlapping packages B and C. For example, in one or more embodiments, the inventory planning system 102 can reserve overlap impressions from both package B and package C proportionally per their percentage of exclusive overlap with package A with respect to package A. In this example, package B has a 10% exclusive overlap with package A, and package C has a 11% exclusive overlap with package A. Since there are 10 impressions to be satisfied, the inventory planning system 102 can deduct 5 impressions from each of package B and package C. If, as another non-limiting example, package B had a 2% exclusive overlap with package A, and package C had an 8% exclusive overlap with package A, the inventory planning system 102 could deduct 2 impressions from package B and 8 impressions from package C based on the proportions of overlap.

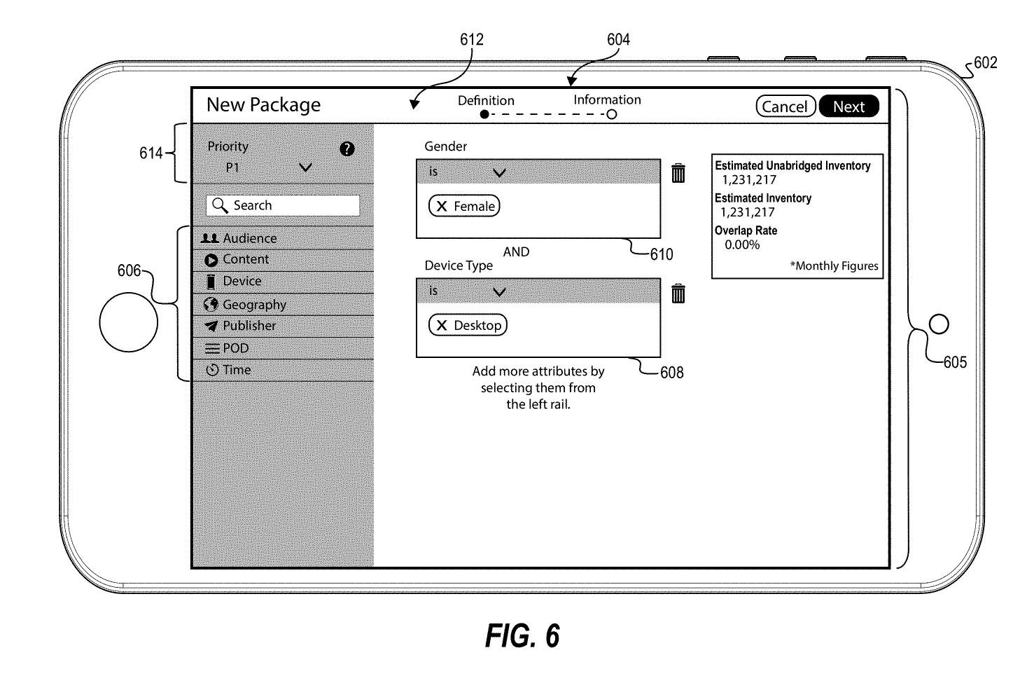

FIGS. 6-10 illustrate a collection of user interfaces including features of the inventory planning system 102 and the publisher system 104 according to one or more embodiments of the present disclosure. As will be described in more detail below, the components of the inventory planning system 102 and the publisher system 104 as described in regard to FIGS. 1-5E can provide, along and/or in combination with the other components, one or more graphical user interfaces (“GUIs”). In particular, the components can allow a user to interact with a collection of display elements for a variety of purposes. For instance, FIGS. 6-10 and the description that follows illustrate various example embodiments of the user interfaces and features that are in accordance with one or more embodiments of the present disclosure.

For example, FIG. 6 illustrates a user device 602 that may implement one or more of the components or features of the inventory planning system 102 and publisher system 104. For purposes of the present disclosure, the user device 602 may be part of (e.g., associated with) the publisher system 104. As shown in FIG. 6, in some embodiments, the user device 602 is a handheld device, such as a tablet device. As used herein, the term “handheld device” refers to a device sized and configured to be held/operated in one or more hands of a user. In additional or alternative examples, however, any other suitable computing device, such as, but not limited to, a mobile phone device, larger wireless device, laptop or desktop computer, a personal digital assistant device, and/or any other suitable computing device can perform one or more of the processes and/or operations described herein.

The user device 602 includes a touch screen display 604 that can display user interfaces. Furthermore, the user device 602 receives and/or detects user input via the touch screen display 604. As used herein, a “touch screen display” refers to the display of a touch screen device. In one or more embodiments, a touch screen device may be the user device 602 with at least one surface upon which a user may perform touch gestures (e.g., a laptop, a tablet computer, a personal digital assistant, a media player, a mobile phone, etc.). Additionally or alternatively, the user device 602 may include any other suitable input device, such as a touch pad or those described below with reference to FIG. 12.

As shown in FIG. 6, the touch screen display 604 of the user device 602 displays an inventory planning system graphical user interface (“GUI”) 605 provided by the inventory planning system 102, which, in some embodiments, may be installed on and/or accessible by the user device 602. As illustrated, in some embodiments, the inventory planning system GUI 605 can include a package creation GUI 612. The package creation GUI 612 includes a plurality of interactive elements for inputting package attributes of a package to be created. In particular, the package creation GUI 612 includes a priority interactive element 614 for inputting (e.g., selecting) a priority of a package. Furthermore, the package creation GUI 612 includes a plurality of attribute interactive elements 606 (e.g., a rail of attribute interactive elements) for inputting attributes such as, for example, a particular age group, gender, denomination, specific content, content genre, content duration, content rating, user device type, location (e.g., country, state, and/or city), time (e.g., time of day and/or day of week).

Moreover, as illustrated, in response to detecting a user interaction with (e.g., a selection of) an attribute interactive element of the plurality of attribute interactive elements 606, the package creation GUI 612 can include attribute windows 608, 610 (e.g., content windows corresponding to the selected attribute interactive elements 606) showing selected attributes (e.g., male or female) corresponding to the selected attribute interactive element. Additionally, each selected attribute interactive element 606 can have a corresponding attribute window 608, 610.

As a result, a user utilizing the user device 602 and package creation GUI 612 of the inventory planning system 102 can select attribute interactive elements from the plurality of attribute interactive elements 606 in order to easily and quickly define (e.g., a create) a package. In particular, a user can create a package utilizing the package creation GUI and using any of the actions described above in regard to acts 201, 202, and 204 of FIG. 2A. For example, the user can select the package attributes through a dropdown box and/or selecting icons that represent different package attributes. In additional embodiments, the user can input the package attributes via an input field of the graphical user interface of the publisher system 104. In some embodiments, the publisher system 104 detects a selection and/or input of the package attributes (e.g., detect a selection of the package attributes via a touch screen). As a non-limiting example, the user, via the user device 602 and package creation GUI 612 of the inventory planning system 102, can define a package as having the attributes of females between the ages of 18 and 30 using iPhones during a week period.

Additionally, as shown in FIG. 7, the inventory planning system GUI 605 provided by the inventory planning system 102 can include an impression information GUI 702. For example, the impression information GUI can include any of the information described above in regard to acts 212, 224, and 234 of FIGS. 2A and 2B. Furthermore, the inventory planning system 102 can provide the impression information GUI to the user device 602 in any of the manners described above in regard to acts 212, 224, and 234 of FIGS. 2A and 2B.

As illustrated in FIG. 7, in some embodiments, the impression information GUI 702 can include a graphical representation 704 (e.g., a bar graph) showing available exclusive impressions, overlap impressions, and percentage overlap of a particular package and/or packages over a period of time. The graphical representation 704 may enable a user to quickly and accurately review an impression inventory of a package and may assist a user in assigning priority to packages (e.g., assigning priority to packages in act 216 of FIG. 2A). For example, based on the exclusive impressions and overlap impressions of a package for a given time period, a user may more effectively assign priorities to maximize usage of available impressions over the period of time.

Moreover, as shown in FIG. 8, the inventory planning system GUI 605 provided by the inventory planning system 102 can include an inventory reservation request creation GUI 802 (e.g., a reservation creation GUI). Furthermore, the inventory reservation request creation GUI 802 can include of a plurality of drop down menus for creating an inventory reservation request (i.e., booking). For example, the inventory reservation request creation GUI 802 can include a package selection element 804 (e.g., a drop-down menu) and a booking period element 806. Additionally, the inventory reservation request creation GUI 802 can include other content windows, selectable elements, and input areas. For example, the inventory reservation request creation GUI 802 can include an input area for designating a desired number of impressions 810. Furthermore, the inventory reservation request creation GUI 802 may include an indication of cost per impression (CPM) 812. Moreover, the inventory reservation request creation GUI 802 can include a tracking ID 814 for the current inventory reservation request. Additionally, in some embodiments, the inventory reservation request creation GUI 802 can include a notification 808 that the current inventory reservation request exceeds the impression inventory of a particular package.

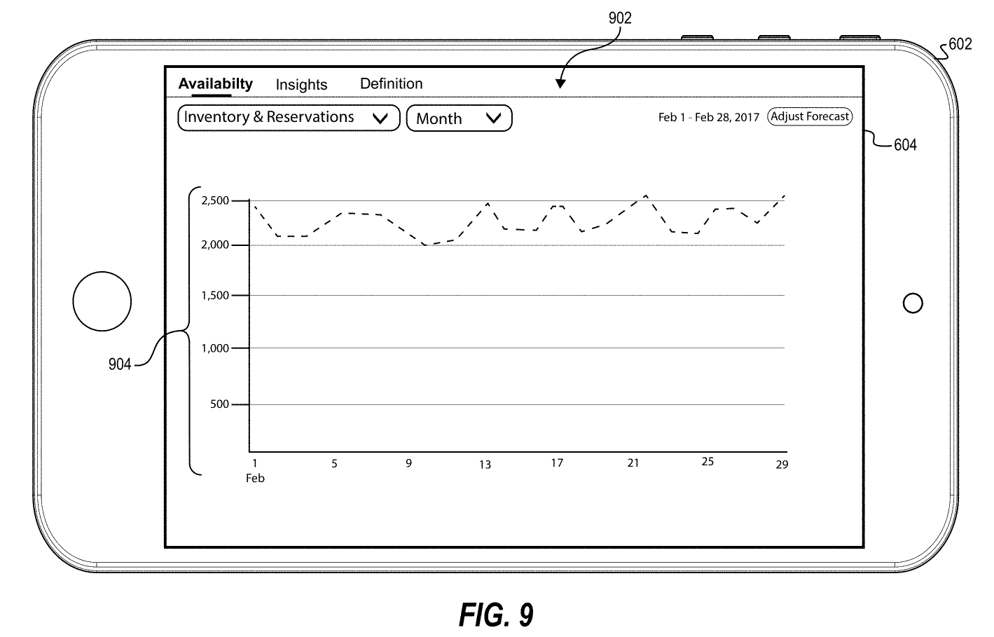

Additionally, in some embodiments, the inventory planning system GUI 605 provided by the inventory planning system 102 can include a package impression inventory GUI 902, as shown in FIG. 9. Furthermore, the package impression inventory GUI 902 can include a graphical representation 904 of an impression inventory (e.g., capacity and bookings) of a selected package (e.g., a package selected via the inventory reservation request creation GUI 802). For instance, in some embodiments, the graphical representation 904 can include a plot graph of the impression inventory of the selected package over a period of time when considering an impression inventory (e.g., overall impression inventory) of the package and inventory reservation requests (e.g., bookings) against the package. In particular, the package impression inventory GUI 902 can include any of the information related to an impression inventory of a package described above in regard to acts 208, 210, and 222 of FIG. 2A.

Moreover, as shown in FIG. 10, the inventory planning system GUI 605 provided by the inventory planning system 102 can include a notification GUI 1002 (e.g., an attention GUI) for indicating to a user (e.g., a user of the user device 602). For example, the inventory planning system GUI 605 can include the notification GUI 1002 when a package has been overbooked by an inventory reservation request. In other words, the inventory planning system GUI 605 can include the notification GUI 1002 when a required number of impressions of an inventory reservation request exceeds a number of available impressions of the package. For instance, the inventory planning system 102 can provide the notification within the actions described above in regard to box 328 of FIG. 3.

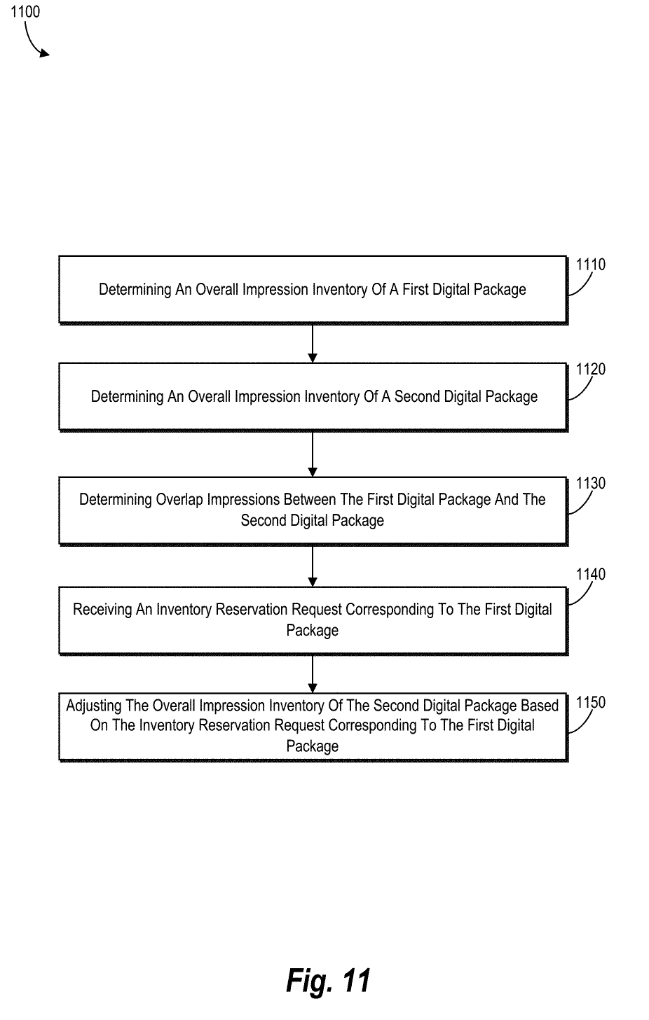

FIG. 11 illustrates a flowchart of an example method 1100 for adjusting package impression inventory based on reservations. The method 1100 can be implemented by the inventory planning system 102 described above. In some embodiments, the method 1100 includes an act 1110 of determining an overall impression inventory of a first package. In particular, the act 1110 may include determining an overall impression inventory of the first package by determining a first set of available impressions of the first package by querying an inventory database. Additionally, the act 1110 can include any of the actions described above in regard to acts 206-210 and 222 of FIG. 2A.

Moreover, the method 1100 includes an act 1120 of determining an overall impression inventory of a second package. For example, the act 1120 may include determining an overall impression inventory of the second package by determining a second set of available impressions of the second package by querying the inventory database. Additionally, the act 1120 may include any of the actions described above in regard to acts 206-210 and 222 of FIG. 2A.

Furthermore, the method 1100 includes an act 1130 of determining overlap impressions between the first package and the second package. For instance, the act 1130 can include determining overlap impressions between the first set of available impressions and the second set of available impressions. In some embodiments, the first set of available impressions includes a first set of exclusive impressions of the first package and the overlap impressions between the first set of available impressions and the second set of available impressions. Moreover, the first set of impressions can include at least one available time segment for receiving third-party content. Additionally, the act 1130 may include any of the actions described above in regard to act 210 FIG. 2A.

Also, the method 1100 includes an act 1140 of receiving an inventory reservation request corresponding to the first package. For instance, the act 1140 can include receiving an inventory reservation request corresponding to the first package from the publisher system. Furthermore, the act 1140 can include receiving an inventory reservation request of the at least one available time segment for receiving third-party content. Moreover, the act 1140 can include any of the actions described above in regard to act 228 of FIG. 2B.

Additionally, the method 1100 includes an act 1150 of adjusting the overall impression inventory of the second package based on the inventory reservation request corresponding to the first package. For instance, the act 1170 can include adjusting, based on the inventory reservation request related to impressions within the first set of impressions of the first package, an overall impression inventory of the second package by reserving at least a portion of the overlap impressions between the first set of impressions and the second set of impressions in response to the inventory reservation request.

Furthermore, the act 1150 can include determining the first set of exclusive impressions of the first package comprises an insufficient number of impressions to satisfy the inventory reservation request; reserving all impressions within the first set of exclusive impressions of the first package based on determining the first set of exclusive impressions comprises an insufficient number of impressions; determining the overlap impressions between the first set of impressions and the second set of impressions comprises a sufficient number of impressions to satisfy a remainder amount of impressions from a difference between a requested number of impressions within the inventory reservation request all impressions within the first set of exclusive impressions; and reserving at least a portion of the overlap impressions to satisfy the remainder amount of impressions. Moreover, the act 1150 can include any of the actions described above in regard to acts 230 and 232 of FIG. 2B.

In further embodiments, the method 1100 can include an act of, in response to receiving the inventory reservation request, reserving an entirety of the first set of exclusive impressions of the first package for the inventory reservation of the first package.

In some embodiments, the method 1100 can also involve an act of receiving third-party content from a third-party content provider, assigning the third-party content to the portion of the first set of impressions having attributes that match the user-defined attributes of the first package, and providing the third-party content to a user device corresponding to the attributes of the reserved impression.

In additional embodiments, the method 1100 can also involve an act of receiving attributes of a third package from the publisher system; generating a third impression inventory associated with the third package based on the received attributes; receiving a first priority of the first package, a second priority of the second package, and a third priority of the third package; determining an overall impression inventory of the third package by identifying a third set of impressions corresponding to the attributes associated with the third package based on the first priority, the second priority, and the third priority and by querying an inventory database; determining overlap impressions between the first set of impressions of the first package and the third set of impressions of the third package; assigning the overlap impressions between the first set of impressions and the third set of impressions to the overall impression inventory of the first package based on the received first priority and third priority; and removing the overlap impressions between the first set of impressions and the third set of impressions from an overall impression inventory of the third package based on the received first priority and third priority.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of an example computing device 1200 that may be configured to perform one or more of the processes described above. One will appreciate that one or more computing devices such as the computing device 1200 may implement the inventory planning system 102 and/or publisher system 104. As shown by FIG. 12, the computing device 1200 can comprise a processor 1202, a memory 1204, a storage device 1206, an I/O interface 1208, and a communication interface 1210, which may be communicatively coupled by way of a communication infrastructure. While an example computing device 1200 is shown in FIG. 12, the components illustrated in FIG. 12 are not intended to be limiting. Additional or alternative components may be used in other embodiments. Furthermore, in certain embodiments, the computing device 1200 can include fewer components than those shown in FIG. 12. Components of the computing device 1200 shown in FIG. 12 will now be described in additional detail.

In one or more embodiments, the processor 1202 includes hardware for executing instructions, such as those making up a computer program. As an example, and not by way of limitation, to execute instructions, the processor 1202 may retrieve (or fetch) the instructions from an internal register, an internal cache, the memory 1204, or the storage device 1206 and decode and execute them. In one or more embodiments, the processor 1202 may include one or more internal caches for data, instructions, or addresses. As an example, and not by way of limitation, the processor 1202 may include one or more instruction caches, one or more data caches, and one or more translation look aside buffers (TLBs). Instructions in the instruction caches may be copies of instructions in the memory 1204 or the storage 1206.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1204 may be internal or distributed memory.

The computing device 1200 includes a storage device 1206 that includes storage for storing data or instructions. As an example, and not by way of limitation, storage device 1206 can comprise a non-transitory storage medium described above. The storage device 1206 may include a hard disk drive (HDD), a floppy disk drive, flash memory, an optical disc, a magneto-optical disc, magnetic tape, or a Universal Serial Bus (USB) drive or a combination of two or more of these. The storage device 1206 may include removable or non-removable (or fixed) media, where appropriate. The storage device 1206 may be internal or external to the computing device 1200. In one or more embodiments, the storage device 1206 is non-volatile, solid-state memory. In other embodiments, the storage device 1206 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The computing device 1200 also includes one or more input or output (“I/O”) devices/interfaces 1208, which are provided to allow a user to provide input to, receive output from, and otherwise transfer data to and receive data from computing device 1200. The I/O devices/interfaces 1208 may include a mouse, a keypad or a keyboard, a touch screen, a camera, an optical scanner, network interface, modem, other known I/O devices or a combination of such I/O device/interfaces. The touch screen may be activated with a stylus or a finger.

The I/O devices/interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1208 is configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 can provide one or more interfaces for communication (such as, for example, packet-based communication) between the computing device 1200 and one or more other computing devices or networks. As an example, and not by way of limitation, the communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can comprise hardware, software, or both that couples components of computing device 1200 to each other.

The foregoing specification is described with reference to specific example embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this invention. Indeed, various modifications of the present disclosure, in addition to those shown and described herein, such as alternative useful combinations of the content features described, may become apparent to those skilled in the art from the description. Such modifications and embodiments are also intended to fall within the scope of the appended claims and legal equivalents.

We claim:

1. A method of adjusting an availability of impressions within an inventory planning database, the method comprising:
analyzing historical analytics data of tracked user interactions with digital content to determine an impression inventory;
maintaining the impression inventory within an inventory database;
based on attributes of a first package, generating a first impression inventory associated with the first package within the inventory database by segmenting the overall impression inventory within the inventory database to identify impressions that correspond to the attributes of the first package,
based on attributes of a second package, generating a second impression inventory associated with the second package within the inventory database by segmenting the overall impression inventory within the inventory database to identify impressions that correspond to the attributes of the second package;
determining the first impression inventory of the first package overlaps the second impression inventory of the second package within the inventory database;
receiving an inventory reservation request related to impressions within the first impression inventory of the first package; and
a step for adjusting, based on the inventory reservation request, the first impression inventory of the first package and the second impression inventory of the second package.

2. The method of claim 1, further comprising:
receiving a first priority of the first package from a publisher system;
receiving a second priority of the second package from the publisher system; and
generating the first impression inventory of the first package and the second impression inventory of the second package based on the first priority and the second priority.

3. The method of claim 1, further comprising:
determining a first set of exclusive impressions within the first impression inventory of the first package;
determining a second set of exclusive impressions within the second impression inventory of the second package; and
determining overlap impressions that are within both the first impression inventory and the second impression inventory.

4. The method of claim 3, wherein receiving the inventory reservation request related to impressions within the first impression inventory of the first package comprises receiving a reservation requiring more impressions than are available in the first set of exclusive impressions.

5. The method of claim 4, further comprising receiving the attributes of the first package in response to a user selection of one or more of an audience, a content, a device type, a publisher, a geographic location, and a time period.

6. The method of claim 1, further comprising:
receiving attributes of a third package;
based on the received attributes of the third package, generating a third impression inventory associated with the third package within the inventory database by segmenting the overall impression inventory within the inventory database to identify impressions that correspond to the attributes of the third package;
determining the third impression inventory of the third package overlaps both the first impression inventory of the first package and the second impression inventory of the second package; and
determining an updated first impression inventory, an updated second impression inventory, and an updated third impression inventory based on determining the third package overlaps both the first impression inventory and the second impression inventory.

7. A method of adjusting an availability of impressions within an inventory planning database, the method comprising:
analyzing historical analytics data of tracked user interactions with digital content to determine an impression inventory maintained within an inventory database, wherein each impression within the overall impression inventory is associated with at least one attribute;
generating, by at least one processor, a first set of impressions for a first package by segmenting the impression inventory within the inventory database based on determining a first set of attributes for the first package comprises the at least one attribute;
generating, by the at least one processor, a second set of impressions for a second package by segmenting the impression inventory within the inventory database based on determining a second set of attributes for the second package comprises the at least one attribute;
determining overlap impressions between the first set of impressions of the first package and the second set of impressions of the second package;
receiving an inventory reservation request for impressions within the first set of impressions of the first package; and
adjusting, based on the inventory reservation request related to impressions within the first set of impressions of the first package, an overall impression inventory of the second package within the inventory database by associating at least a portion of the overlap impressions between the first set of impressions and the second set of impressions to the inventory reservation request.

8. The method of claim 7, wherein the first set of impressions of the first package comprises a first set of exclusive impressions and the overlap impressions between the first set of impressions and the second set of impressions.

9. The method of claim 8, further comprising, in response to receiving the inventory reservation request, reserving an entirety of the first set of exclusive impressions of the first package for the inventory reservation of the first package.

10. The method of claim 8, wherein adjusting the overall impression inventory of the second package within the inventory database further comprises:
determining that a total amount of impressions within the first set of exclusive impressions of the first package is less than an amount of requested impressions within the inventory reservation request;
associating, with the inventory reservation request within the inventory database, the total amount of impressions within the first set of exclusive impressions of the first package based on determining the total amount of impressions within the first set of exclusive impressions is less than the amount of requested impressions;
determining that an overlap amount of impressions within the overlap impressions between the first set of impressions and the second set of impressions is equal to or greater than a remainder amount of impressions, wherein the remainder amount of impressions is a difference between the amount of requested impressions and the total amount of impressions within the first set of exclusive impressions; and
associating, with the inventory reservation request within the inventory database, a portion of the overlap impressions equal to the remainder amount of impressions.

11. The method of claim 7, further comprising;
receiving the first set of attributes of the first package and the second set of attributes of the second package from a publisher system; and
receiving the inventory reservation request from a third-party system.

12. The method of claim 11, wherein the first set of attributes defines a first audience and the second set of attributes define a second audience.

13. The method of claim 7, further comprising:
receiving, from a third-party system, an inventory reservation request for impressions within the second set of impressions of the second package; and
adjusting, based on the inventory reservation request related to impressions within the second set of impressions of the second package, an overall impression inventory of the first package within the inventory database by associating at least a portion of the overlap impressions between the first set of impressions and the second set of impressions to the inventory reservation request related to impressions within the second set of impressions of the second package.

14. The method of claim 7, further comprising:
receiving third-party content from the third-party content provider;
assigning the third-party content to reserved impressions corresponding to the inventory reservation request; and
providing the third-party content to a user device associated the first set of attributes.

15. The method of claim 7, further comprising:
receiving a first priority of the first package and a second priority of the second package; and
assigning a first portion of the overlap impressions to the first set of impressions and a second portion of the overlap impressions to the second set of impressions based on the first priority and the second priority.

16. A system for adjusting an availability of digital impressions within an inventory planning database, the system comprising:
an inventory database comprising a plurality of prioritized packages, each package of the plurality of prioritized packages comprising exclusive impressions and overlap impressions; and
a computing device comprising instructions thereon that, when executed by at least one processor, cause the system to:
determine an impression inventory for a first package of the plurality of packages within the inventory database based on the exclusive impressions and the overlap impressions of the first package of the plurality of packages;
with respect to the first package, determine overlap impressions within the inventory database shared between the first package and an overlapping package;
receive an inventory reservation request for impressions within the impression inventory for the first package of the plurality of packages; and
adjust an impression inventory for the overlapping package and the impression inventory for the first package based on the inventory reservation request.

17. The system of claim 16, wherein adjusting the impression inventory for the overlapping package and the impression inventory for the first package is based on a priority of the overlapping package and a priority of the first package.

18. The system of claim 16, wherein:
the priority of the overlapping package equals the priority of the first package; and
adjusting the impression inventory for the overlapping package and the impression inventory for the first package comprises reducing the impression inventory for the overlapping package and the impression inventory for the first package by an equal amount of impressions.

19. The system of claim 16, wherein:
the priority of the overlapping package is greater than the priority of the first package; and
adjusting the impression inventory for the overlapping package and the impression inventory for the first package comprises reducing the impression inventory for the overlapping package an amount less than an amount reduced for the first package.

20. The system of claim 19, wherein adjusting the impression inventory for the overlapping package and the impression inventory for the first package comprises adjusting only impressions within the overlapping package.
